(19) United States
(12) Patent Application Publication
(10) Pub. No.: US 2003/0110140 A1
(43) Pub. Date: Jun. 12, 2003

(54) Method for facilitating pricing, sale and distribution of fuel to a customer

(76) Inventors: Louis Morrison III, Dallas, TX (US); Scott Williams, Rockwall, TX (US); Susan Sims, Richardson, TX (US); Jamie Dulaney, Highland, TX (US); Leslie Vandagriff, Arlington, TX (US); Gail Woody, Grand Prairie, TX (US); Shelly Harlan, Dallas, TX (US); Al Shields, Benbrook, TX (US); Rick Surles, Waxahachie, TX (US); Neil Strong, Plano, TX (US); Darin Morse, Richardson, TX (US)

Correspondence Address: Erik B. Cherdak & Associates, LLC, Suite 906, 11300 Rockville Pike, Rockville, MD, 20852, US

(21) Appl. No.: 09/895,011

(22) Filed: Jun. 28, 2001

(51) Int. Cl. G06F 17/00

(52) U.S. Cl. 705/400

(57) ABSTRACT

New and improved systems and methods for facilitating sale and distribution of fuel to a fuel customer. Such systems and methods include and involve a server facility configured to store fuel deal data and to process such fuel deal data to automatically generate pricing data based on the fuel deal data and in accordance with a pre-determined pricing technique. The system and method also include and involve a client facility that is coupled to the server facility via an electronic data network and which is configured to permit a user to enter such fuel deal data and to cause the server facility to store and process the fuel deal data to generate the pricing data. As such, fuel may be sold and distributed to a fuel customer via a fuel distribution system based on the fuel deal data and the automatically generated pricing data.

Attached hereto is a compact disc containing computer software and data including executable programs, scripts, and database management system tables that are used to implement the systems and methods provided by the present invention. More particularly, the attached compact disc contains software and data used to implement at least two distinct applications comprising the systems and methods provided by the present invention; such two distinct applications include a broad-based, general use energy management system (referred to as the Energy Management System “EMS”), and a limited user/function restricted application (referred to as the Producer Control Center “PCC”) intended for use by fuel producers needing access to centrally stored and managed fuel deal data. Such material is protected by the Copyright Laws of the United States (17 U.S.C. § 101, et seq.) and may not be copied without the express, written authorization of the copyright holder (Highland Energy Corporation). Copyright © 2001, Highland Energy Corporation. All Rights Reserved.

### BACKGROUND OF THE INVENTION

1. Field of the Invention

The present invention relates to systems and methods used to facilitate pricing, sale, and distribution of fuel to a customer. More particularly, the present invention is directed to automated systems and methods that are used to price fuels such as natural gas, oil, gas, other petroleum based fuels, etc., to facilitate commodity sales of such fuels, and to distribute such fuels to customers, and to track and report sales and distribution related data.

2. Description of the Related Art

Fuel sales and distribution systems and techniques are well known. Everyday millions of fuel sale contracts are completed in the U.S. and abroad. Fuels produced by a range of producers are transported over many modes of transportation (e.g., gas pipelines, etc.) to ultimately arrive at an intended destination. The steps involved in pricing fuel, selling a reserve, storing reserves, and ultimately transporting purchased fuel involve many parties including producers, agents, brokers, other middlemen and, ultimately, end customers. All of these parties have their own unique ways of doing business, reporting sale and purchase data, and collecting and paying against agreed upon contracts.

Unfortunately, many of the steps and processes carried out to facilitate fuel sales and distribution are archaic, inefficient, and, often, paper-based. Such inefficient ways of doing business cause many parties to engage large teams of personnel to manage the intricate details often involved in fuel sale and distribution. Fuel deal pricing provides a good example of the inefficiencies involved in moving large volumes of natural gas and other fuels.

Typically, pricing fuel deals in the natural gas arena involves manual processes related to gathering fuel index rates, manually computing sales prices across a multitude of fuel sales deals, laboriously factoring in transportation and other tangential costs, and managing for fuel overages and short falls often associated with transportation anomalies, etc. These processes typically involve the efforts of large teams of personnel within organizations who are required to constantly monitor sales deals, set pricing limits for sales people, and track and record fuel deal progress.

While many systems have been developed to facilitate sale and distribution of fuel and other products, commodities, and services in general, no systems developed to date can effectively management the volume of transactions among a wide array of parties to efficiently and effectively get fuel from one place to another. Moreover, existing systems have heretofore not been able to facilitate pricing practices that factor in past fuel deal data across a multitude of prior fuel deals to better drive profit margins in the commodities and brokerage fields.

Accordingly, there exists a serious need to provide systems and methods that enable centralized location and management of fuel deal data, provide for application of pre-determined pricing techniques based on such fuel deal data, facilitate broad-based reporting based on such centrally stored fuel deal data to drive better business practices for parties to fuel deals, and increase productivity and make more efficient fuel sale and distribution practices. The present invention squarely addresses such a need and provides a new and improved systems and methods for facilitating fuel sale and distribution.

### SUMMARY OF THE INVENTION

The present invention solves the problems mentioned above with regard to prior systems and methods used to facilitate sale and distribution of fuel to a customer. By squarely addressing the limitations of prior systems and methods, the present invention provides new and improved systems and methods that permit a wide array of users to broadly access a central data store to create and manage fuel deal data. Such new and improved systems and methods further permit the inclusion of pricing processes into existing business processes that are based on prior fuel deal data and which take into account prior prices charged across collections of prior fuel deal contracts.

Accordingly, the present invention provides new and improved systems and methods for facilitating sale and distribution of fuel to a fuel customer. Such systems and methods include and involve a server facility configured to store fuel deal data and to process such fuel deal data to automatically generate pricing data based on the fuel deal data and in accordance with a pre-determined pricing technique. The system and method also include and involve a client facility that is coupled to the server facility via an electronic data network and which is configured to permit a user to enter such fuel deal data and to cause the server facility to store and process the fuel deal data to generate the pricing data. As such, fuel may be sold and distributed to a fuel customer via a fuel distribution system based on the fuel deal data and the automatically generated pricing data.

### BRIEF DESCRIPTION OF THE DRAWINGS

The present invention is described in detail below with reference to the following drawing figures, of which:

FIG. 1 is a timing diagram that depicts process flows within a business process that facilitates sale and distribution of fuel to customers in accordance with a preferred embodiment of the present invention;

FIG. 2 is a system diagram in which client systems can access server system(s) to facilitate sale and distribution of fuel to customers in accordance with the business process illustrated in FIG. 1;

FIG. 3A is an entity relationship diagram that depicts data relationships among tables and corresponding table entries used to implement the systems that carry out the business process illustrated in FIG. 1;

FIG. 3B is another entity relationship diagram that depicts data relationships among tables and corresponding table entries used to implement the systems that carry out the business process illustrated in FIG. 1;

FIG. 3C is another entity relationship diagram that depicts data relationships among tables and corresponding table entries used to implement the systems that carry out the business process illustrated in FIG. 1;

FIG. 3D is another entity relationship diagram that depicts data relationships among tables and corresponding table entries used to implement the systems that carry out the business process illustrated in FIG. 1;

FIG. 3E is another entity relationship diagram that depicts data relationships among tables and corresponding table entries used to implement the systems that carry out the business process illustrated in FIG. 1;

FIG. 3F is another entity relationship diagram that depicts data relationships among tables and corresponding table entries used to implement the systems that carry out the business process illustrated in FIG. 1;

FIG. 3G is another entity relationship diagram that depicts data relationships among tables and corresponding table entries used to implement the systems that carry out the business process illustrated in FIG. 1;

FIG. 3H is another entity relationship diagram that depicts data relationships among tables and corresponding table entries used to implement the systems that carry out the business process illustrated in FIG. 1;

FIG. 3I is another entity relationship diagram that depicts data relationships among tables and corresponding table entries used to implement the systems that carry out the business process illustrated in FIG. 1;

FIG. 3J is another entity relationship diagram that depicts data relationships among tables and corresponding table entries used to implement the systems that carry out the business process illustrated in FIG. 1;

FIG. 3K is another entity relationship diagram that depicts data relationships among tables and corresponding table entries used to implement the systems that carry out the business process illustrated in FIG. 1;

FIG. 3L is another entity relationship diagram that depicts data relationships among tables and corresponding table entries used to implement the systems that carry out the business process illustrated in FIG. 1;

FIG. 3M is another entity relationship diagram that depicts data relationships among tables and corresponding table entries used to implement the systems that carry out the business process illustrated in FIG. 1;

FIG. 3N is another entity relationship diagram that depicts data relationships among tables and corresponding table entries used to implement the systems that carry out the business process illustrated in FIG. 1;

FIG. 4A is another screen shot of a data processing application running within a client system to facilitate at least some of the operations carried out to effect the business process illustrated in FIG. 1;

FIG. 4B is another screen shot of a data processing application running within a client system to facilitate at least some of the operations carried out to effect the business process illustrated in FIG. 1;

FIG. 4C is another screen shot of a data processing application running within a client system to facilitate at least some of the operations carried out to effect the business process illustrated in FIG. 1;

FIG. 4D is another screen shot of a data processing application running within a client system to facilitate at least some of the operations carried out to effect the business process illustrated in FIG. 1;

FIG. 4E is another screen shot of a data processing application running within a client system to facilitate at least some of the operations carried out to effect the business process illustrated in FIG. 1;

FIG. 4F is another screen shot of a data processing application running within a client system to facilitate at least some of the operations carried out to effect the business process illustrated in FIG. 1;

FIG. 4G is another screen shot of a data processing application running within a client system to facilitate at least some of the operations carried out to effect the business process illustrated in FIG. 1;

FIG. 4H is another screen shot of a data processing application running within a client system to facilitate at least some of the operations carried out to effect the business process illustrated in FIG. 1;

FIG. 4I is another screen shot of a data processing application running within a client system to facilitate at least some of the operations carried out to effect the business process illustrated in FIG. 1;

FIG. 4J is another screen shot of a data processing application running within a client system to facilitate at least some of the operations carried out to effect the business process illustrated in FIG. 1;

FIG. 4K is another screen shot of a data processing application running within a client system to facilitate at least some of the operations carried out to effect the business process illustrated in FIG. 1;

FIG. 4L is another screen shot of a data processing application running within a client system to facilitate at least some of the operations carried out to effect the business process illustrated in FIG. 1;

FIG. 4M is another screen shot of a data processing application running within a client system to facilitate at least some of the operations carried out to effect the business process illustrated in FIG. 1;

FIG. 4N is another screen shot of a data processing application running within a client system to facilitate at least some of the operations carried out to effect the business process illustrated in FIG. 1;

FIG. 4O is another screen shot of a data processing application running within a client system to facilitate at least some of the operations carried out to effect the business process illustrated in FIG. 1;

FIG. 4P is another screen shot of a data processing application running within a client system to facilitate at least some of the operations carried out to effect the business process illustrated in FIG. 1;

FIG. 4Q is another screen shot of a data processing application running within a client system to facilitate at least some of the operations carried out to effect the business process illustrated in FIG. 1;

FIG. 5A is a flow chart that illustrates the operations carried out to effect a pricing technique and, in particular, one that effectuates a weighted average sales price for fuel deals in accordance with a preferred embodiment of present invention; and

FIG. 5B is the conclusion of the flowchart started in FIG. 5A.

### DETAILED DESCRIPTION OF THE PREFERRED EMBODIMENTS

The present invention is now described in detail with regard to the drawing figures that were briefly described above. The systems and methods described herein are illustrative of the exemplary system implemented by way of computer software within a networked data processing environment and which is contained within multiple files housed on the compact disc that is appended to this patent document. Accordingly, the discussion that follows refers to such an exemplary system and those skilled in the art are encouraged to review such appended software in the context of fuel deal management for a complete understanding of the present invention. As noted at the beginning of this patent document, the material contained on the attached compact disc is protected by the Copyright Laws of the United States (17 U.S.C. § 101, et seq.) and may not be copied without the express, written authorization of the copyright holder (Highland Energy Corporation). Copyright © 2001, Highland Energy Corporation. All Rights Reserved.

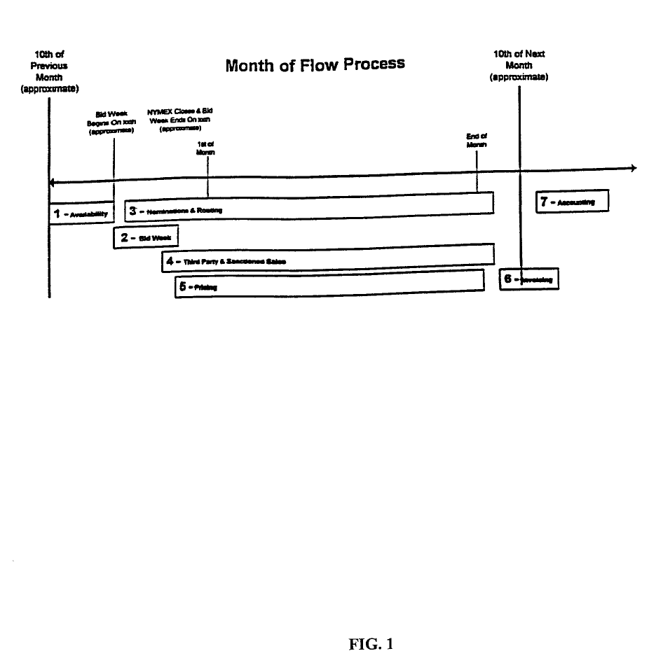

Referring now to FIG. 1, depicted therein is a timing diagram corresponding to the business process carried out within an organization to facilitate sale and distribution of fuel to a customer and which may be set up to utilize the systems and methods provided by the present invention. In particular, FIG. 1, illustrates a monthly or periodic business process involving several phases of operation that are carried out by the systems and methods provided by the present invention including, but not limited to: an availability phase, a bidding phase, a nominating (e.g., gas pipeline nominations, etc.) and routing phase, a third party and sanctioned sales period, a pricing period, an invoicing period, and an accounting period. Together, these periods make up what is referred to herein as a MONTH OF FLOW PROCESS (MFP). The MFP is described next to further illustrate the business operations that are handled by the systems and methods provided by the present invention.

### THE MONTH OF FLOW PROCESS (MFP)

### Availability Period

During the availability period of the month of flow process, equity contracts for sale and distribution of fuel (those that need to roll from month to month) are established for the next month. These purchase deals define the anticipated volumes by well/meter for each producer. The status for the production month needs are set to ‘Availability’ at this point. Then, correspondence is transferred (via fax, email and phone conversations) to the various operators/producers in order to confirm the anticipated volumes to be produced.

The anticipated production volume for an entire well/meter is then entered into the system. An entitlement and makeup percentage is used to indicate how much of this volume is actually available to be marketed (represents the owner interest in the production of the well/meter). New deals are setup on the system to represent the new month's purchases. The package description is utilized to assist with easy recognition of volumes, price, etc. (used for identification purposes only). There is a process built within the system to automate the propagation of new deals to the next month (first time into a new month will automatically generate entries for the new month with zero volume amounts). The actual volume stored on the system (at this point) is zero. Only the nominated volumes contain the expected volumes for the production month. These “nominated” volumes are equal to the estimates provided by the producers and entered into the system during this part of the month of flow. The primary area of the system utilized is the ‘Availability’ functions (off the system's main menu.)

### Bid Week Period

During the bid week of the month of flow process, buyers are found for the volumes that were made available through the availability step described above. The status of the production month of the system needs is set to “Sales” at this point. By setting the status to ‘Sales’ all of the price indices will be initially populated and ‘seeded’ with zero values. Each of the sales is confirmed by a dealmaker and is written up on a deal log sheet. These deal log sheets reflect the pipe/field, meter/well, company, contract, volume, and pricing instructions to support the sale. Prior to completing a deal, the dealmaker will work closely with the volume control group to ensure that appropriate volumes will be available at the well/meter of sale. The dealmakers then complete the deal log sheet entries for the sale and they are transferred to the volume control group for deal creation and entry into the system. Most of the volumes sold during this particular phase are for the equity purchase deals created during the availability period.

### Nominating and Routing

During the nominating and routing period of the month of flow process, the volumes to support the sales are routed from the producer's well/meters to the sales wells/meters (primarily to pooling points or field tanks). This process occurs throughout the entire month. When the volumes are routed to specific pool wells/meters, allowances are automatically made by the system for fuel, gathering and transport costs. These costs will net down the actual available volumes that can be applied to the sales deals. When volumes are routed to a pool/tank then these volumes reflect as ‘Transport Out volumes’. The volumes then show up as “Transported In” (net fuel) on the receiving meter/well within the system. The primary area with the System utilized during this process is the “Route Volume” menu option within the Routing module (main menu selection of ‘Routing’ on the System.

### Third Party Deals and Sanctioned Sales

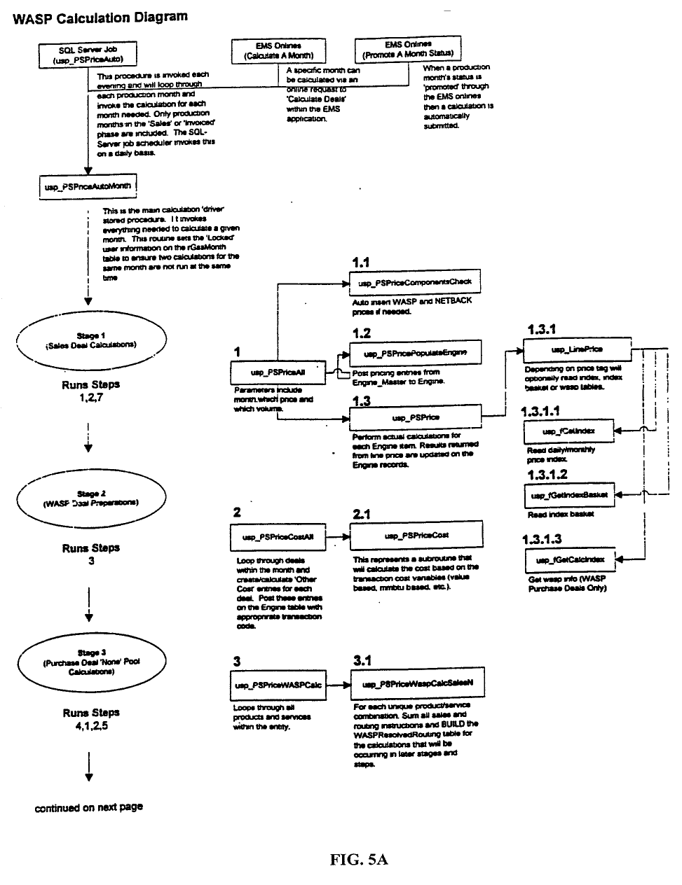

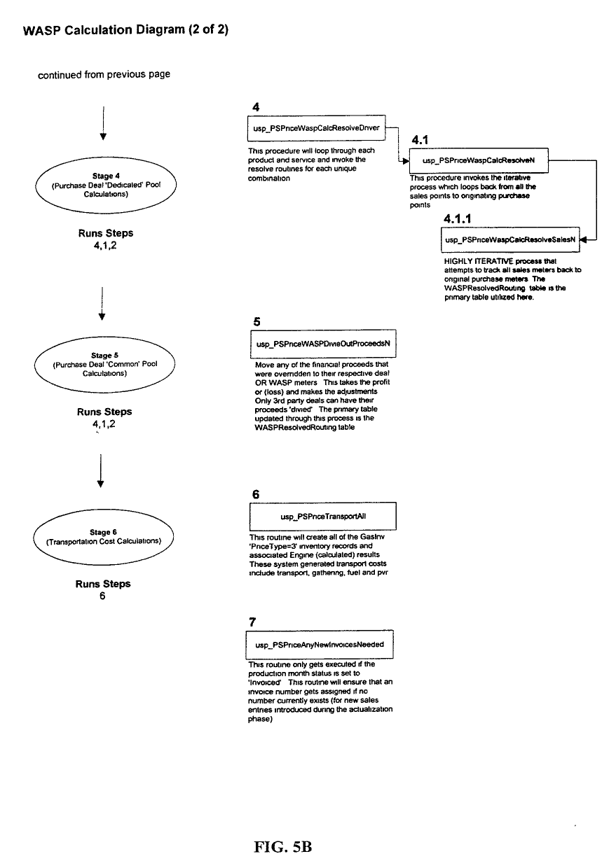

During the Third Party Deals and Sanctioned Sales of the month of flow process, the dealmakers complete the third party deals. These deals are typically setup where a specific purchase deal (non equity type) is made to support a specific sales deal. These types of deals will usually have a specific price agreement and volume associated with them. Sanctioned sales represent sales from equity volumes with specific terms (prices, volumes, etc.) to specific sales meters. A sales price for a specific volume is set in advance of the production month with these types of deals. All third party deals are excluded from Weighted Average Sales Price (WASP) calculations as discussed below with regard to FIGS. 5A and 5B (each third party purchase volume exists within its own WASP pool (‘None’)). All sanction sales deals are included within the WASP calculation but EACH combination sanction sales (purchase-to-sale) will utilize a ‘Dedicated’ WASP pool during the calculation. In this way, sanction sale costs etc. PLUS netback percentages can be applied. All equity deals combined with the ‘Common’ WASP pool where costs and prices are aggregated by meter/well based on volume weightings. All deals actually go through the calculation in order determine margins. However, the calculation has been setup to ensure that third party, sanctioned sale and equity pools are calculated without interfering with each other.

### Pricing

During the pricing period of the month of flow process, all monthly index based prices are entered immediately when published. These are usually entered just before the beginning of the production month. Daily prices are keyed or otherwise entered throughout the month as they are received. When deals are setup the ‘Pricing’ function within the System is used to actually calculate a price for the deal (‘Price’ tab on deal detail screen). Each evening, for example, the ‘Price All Deals’ function of the System is started. This particular function will re-price all deals for the entire month (Price+WASP calculations). For months in the ‘Sales’ phase, the nominations are re-priced and recalculated. For months in the ‘invoiced’ phase, the pipe/field actuals are re-priced and recalculated. In addition, to this periodic process, an option exists within the System to price production months throughout a day, for example. Below, with reference to FIGS. 5A and 5B, the details related to fuel deal pricing are described. The ability of the present invention to incorporate a pricing technique such as one that is predetermined and implemented as a modular component of a larger software system, represents a significant point of novelty to which the present invention is directed.

### Invoicing

During the invoicing period of the month of flow process, invoices for all of the sales for the previous month are produced. This represents the final step of the month within the system. All marketing individuals directly involved with the system for the month (controllers, dealmakers, etc.) are informed that the month is closing out and that invoices are now being produced. The status for the production month is changed to ‘Invoiced’. A final nomination calculation is automatically done with the status updated. Accounting is then notified that the month has been completed. Invoicing reports are then run for the month and sent to the buyers by an accounting group, for example. Additional reports may be run (Sales By Pipe/Field, Purchase By Producer, Balancing Reports, Pipeline Statement Comparison Reports, etc.) by the accounting group for historical reference and reconciliation.

### Accounting

During the accounting period of the month of flow process, an accounting group creates a revenue and journal entry feed to track receivables within an automated accounting system. This feed is created directly out of the system. Pipe/Field statements begin appearing beginning as early as the 15^{th} of the month. These statements represent volumes (by well/meter) for the previous month. Each accounting analyst is responsible for a specific set of pipe/fields. The volumes from these statements are entered as actuals into the system. A copy of the Pipe/Field statements are sent to the controllers for sign off. Accounting analysts then balance all of the purchase meter routing information for their respective pipe/fields. Accounting analysts then balance all of the sales meters for their respective pipe/fields. Accounting analysts then adjust any route volumes that cross pipe/fields to ensure interconnect balances are synchronized with pipe/field statements. Reconciliation and voucher reports can be run immediately after the production month is promoted to ‘Accounting’ phase (meaning accounting is finished with the month). These reports can then be sent to producers and/or entered into to accounting system.

### AN EXEMPLARY SYSTEM

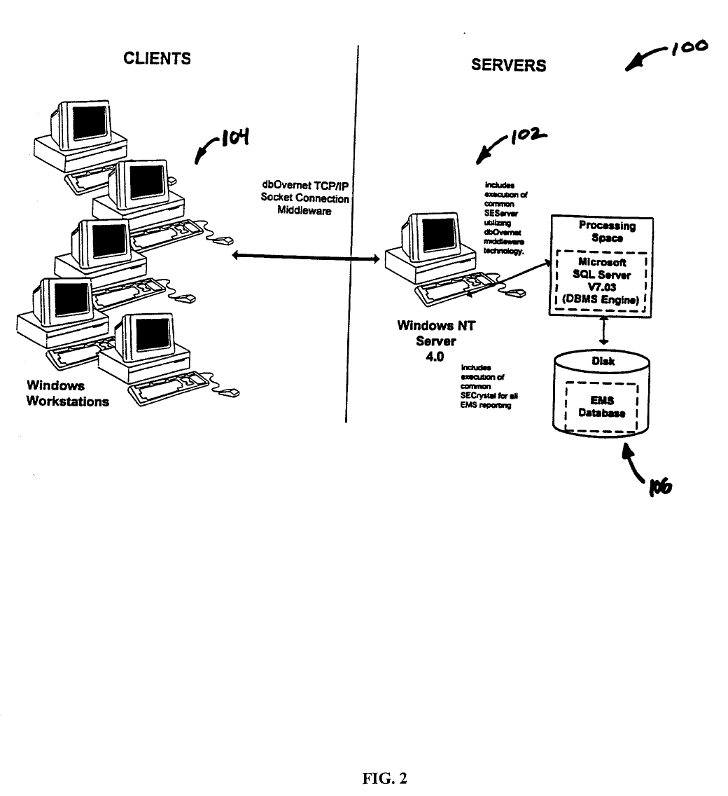

Referring now to FIG. 2, depicted therein is a diagram of an exemplary system in which client systems can access server system(s) to facilitate sale and distribution of fuel to customers in accordance with the business process (MFP) illustrated in FIG. 1. In particular, system 100 includes both server(s) 102 and client systems 104. Additionally, a database management system and corresponding data store 106 (hereinafter data store 106) is used to store fuel deal data and programs. Servers 102 are configured to be accessed via wide area network connections such as those facilitated via the Internet using open standards based protocols. Client systems 106 are configured with software contained on the appended compact disc to access servers 102 to engage in fuel deal operations such as those described with reference to the month of flow process (MFP) discussed above with regard to FIG. 1.

In FIG. 2, client systems 104 may be configured as desktop computing systems, wireless computing clients, etc. to access servers 102. Such access may be made possible via applications and technology such as dbOvernet TCP/IP Socket Connection Middleware. Furthermore, servers 102 execute common SEServer applications and routines utilizing dbOvernet middleware technology.

Within the processing space of servers 102, a database server system such as Microsoft's SQLServer V.7.03 (a DBMS engine) may be instantiated. Such a database management system may control data store 106 and may be configured in accordance with the present invention to maintain all fuel deal data in accordance with the present invention.

The following discussion further defines an exemplary arrangement for a client-server system implemented in accordance with the present invention:

### SERVERS

MS Windows NT 4.0 (SP6) may be chosen as a Network Operating System.

The DBMS may be Microsoft's SQL-Server (V7.0x)—Service Pack 3. All data generated and processed within the context of the present invention is stored in MS SQL-Server database tables. Such data is accessed via direct SQL statements (embedded in Windows applications, stored procedures, forms, and reports). There are several database views that have been setup to access aggregated information (for performance and consistency). In addition, all of the critical calculations and time consuming procedures such as pricing calculations, routing and rollover processes, etc. are written as Transact-SQL stored procedures and are contained on the attached compact disc and are discussed in further detail below in the embedded description-tables found herein.

The SEServer may be a Middleware Server Application. The system database is accessed via middleware software that uses TCP/IP (SEServer/dbOvernet). All databases queried through the system come through this middleware component.

SECrystal (Crystal Reporting Engine Server Application) may be used for server side reporting functions, etc. All reports for the system utilizes a remote Crystal Reporting engine (SECrystal) server. These reports are run and saved on the server for electronic distribution. Crystal Report (V8.0) from Seagate Software is used for this function.

The SEFax (Fax Server Application) may be used for Fax distribution. This server application is responsible for sending out reports via a fax device. This software monitors a specific directory and when a fax file ‘shows up’ in the directory it will be faxed.

The MAPI Mail Client Software provides Email (like Microsoft Outlook or Outlook Express). The MAPI compliant email service needs to be running on the same machine as the report engine server (SECrystal). This provides the ability to email reports (Correspondence) automatically. Options should be set on this client to automatically check (send/receive) at periodic intervals.

The Adobe Acrobat Reader (Free PDF Viewer) is used to view reports, etc. The server machine that runs the SECrystal reporting server application needs to also have the PDF viewer installed. This is used in order to ‘spool’ to paper the print jobs.

### WEB ACCESS—NETWORK CONNECTIVITY

All functions within the System are available over the Internet (with appropriate security). An individual wishing to log in to the system over the Internet will need to have appropriate application security to log in, the current application executable program (as contained on the attached compact disc) and an ISP account. System administrators will need to furnish access site addresses (e.g., IP addresses, domain names, etc.) to users to address the systems provided by the present invention.

### CLIENT SYSTEMS

Client systems may utilize a Client Operating System such as MS-Windows 95/98/Me; MS-Windows NT 4.0/2000. TCP/IP network protocol is required. Access to the server TCP/IP address (either LOCAL address or REMOTE address is required.)

The system typically includes a single .EXE file(s) (plus approximately 8 disk compression and graphics DLL's). The system application require only a single executable with a few DLL's to reside on the client machine. No other client configuration software is required. Upgrades to the client software are automatically done when a user first connects (logs in) through the Internet (on application startup). A version number check will be made if necessary and a new installation program and script are automatically downloaded.

The Adobe Acrobat Reader (FREE PDF view) is used as a reporting system for files saved in the PDF 1.2 format. The default output for all reports on the system is the standard PDF format. This provides for email/electronic storage. In order to view reports this software (or other third party viewer with a file association to .pdf files) needs to exist on the client machine.

The MAPI Mail Client Software is used for electronic mail communications. A MAPI compliant email service needs to be running on the client machine to be able to highlight a report and email it using the client email address list. This software is not required to run the but is required to take advantage of the system's ability to attach reports automatically within an email client.

All client applications are written using DELPHI (V5+) including Delphi 3^{rd} party tools and procedures. Such applications and stored procedures and identified 3^{rd} party tools are further described in the description-tables found below.

### DATABASES, AND CORRESPONDING ENTITY RELATIONSHIPS

The various database tables that make up the system have been divided into nine (9) database subject areas. A subject area within this context is simply a logical aggregation of tables that support a particular business or system function. All of the database tables physically reside in the same database, but are not required to so reside. Only the documentation (as described below) has been constructed to illustrate these subject areas. It is also important to note that there are linkages (not documented here) between the various subject areas.

These database subject areas and a description include:

Companies: All company related tables (including company name, contact name, addresses functions, etc.).

Contracts: All contract related tables (including contract provisions, notes, default standard reporting, etc.).

Deals: All deal related tables (includes other costs, deal classes, correspondence, etc.).

Volume Inventory: All volume inventory tables (includes production interests, daily monthly, calculated values, etc.).

Operational: All tables that were created to support the system (software application). These tables include fax queue tables, printer definition tables, system logs, system messages, reporting tables, etc.

Pipes/Fields: All pipe/field and meter/well related tables.

Pricing: All tables within the system that are related to pricing (indices, price descriptions, baskets, etc.).

Routing: All tables within the system that define routes (leg definitions, daily leg rates, monthly leg rates, nom and actual volume routing instructions, etc.).

Security: All security related tables within the system (includes user, logins, passwords, business functions, etc.).

The above-described nine (9) logical database subject areas are next broken down into the actual tables that reside on the attached compact disc. For purposes of brevity, such database subject areas are broken down in the following tables:

Table Descriptions

Below is an inventory of the various database tables that are utilized by the Energy Management System. This particular inventory indicates the current number of rows (through January 2001), the database (MS SQL Server) and the database subject areas (logical grouping of tables).

| | | | | | |
|---|---|---|---|---|---|
| | | | | Subject | |
| Ref # | Table Name | Rows | Database | Area | Description/Comments |

Companies
Subject Area

| | | | | | |
|---|---|---|---|---|---|
| 1.0 | Address | 1,384 | SQL Server | Companies | Contains record entries for each address for all |
| | | | | | companies and contacts within companies |
| | | | | | (multiple address types per company and/or |
| | | | | | contact). |
| 2.0 | Company | 1,242 | SQL Server | Companies | Contains a record entry for each company in |
| | | | | | the database. Information on this table |
| | | | | | includes company name, fax, phone and |
| | | | | | primary address reference identifier. |
| 3.0 | Contact_Group | 908 | SQL Server | Companies | Contains a record entry for each contact group |
| | | | | | relationship. This is the mechanism for |
| | | | | | grouping company contact individuals.. |
| 4.0 | Contact_GroupNames | 8 | SQL Server | Companies | Contains a record entry for each contact group |
| | | | | | name. |
| 5.0 | ContactFunction | 997 | SQL Server | Companies | Contains a record entry showing the contact to |
| | | | | | function relationships for a given company. |
| 6.0 | Contacts | 3,347 | SQL Server | Companies | Contains a record entry for each individual |
| | | | | | contact in the database. Includes full name, |
| | | | | | phone, fax, email, title, etc. |

Contracts
Subject Area

| | | | | | |
|---|---|---|---|---|---|
| 10.0 | K | 1,414 | SQL Server | Contracts | This table contains a record entry for each |
| | | | | | contract within the system. Bank information |
| | | | | | (ABA), Evergreen indicators, termination date, |
| | | | | | fixed pricing, etc. type data attributes are stored |
| | | | | | on these records. Each contract on the system |
| | | | | | has an associated parent ‘company’ (on the |
| | | | | | Company table). |
| 11.0 | KNetBack | 334 | SQL Server | Contracts | This table contains the netback pricing tiers |
| | | | | | associated with a given contract. The parent |
| | | | | | table for this entity is the contract table (K). |
| | | | | | The netback pricing tiers are volume and date |
| | | | | | influenced. |
| 12.0 | Knotes | 589 | SQL Server | Contracts | This table contains an optional record entry for |
| | | | | | each contract on the system. If there are no |
| | | | | | notes associated with a contract then the |
| | | | | | records are not inserted on the database. This |
| | | | | | provides the users with a free form area for |
| | | | | | keeping notes about a contract. |
| 13.0 | Kproducts | 1,049 | SQL Server | | This table contains a reference to the products |
| | | | | | that are available (oil, gas, liquids, etc.) for a |
| | | | | | given contract. A product has to be associated |
| | | | | | to a contract before a deal can be setup using |
| | | | | | that contract for that product. |
| 14.0 | KreportDefaults | 48 | SQL Server | | This table contains the entire standard |
| | | | | | reporting defaults for a particular entity. These |
| | | | | | reports include invoices, remittance, vouchers, |
| | | | | | deal confirmations, etc. |
| 15.0 | KreportOverrides | 0 | SQL Server | | If a particular contract has its own unique |
| | | | | | standard reports then a reference to these |
| | | | | | unique reports is stored in this table for the |
| | | | | | contract in question. |
| 16.0 | Kservices | 1,068 | SQL Server | | This table contains a reference to the services |
| | | | | | that are available (marketing, end user, pass |
| | | | | | thru, etc.) for a given contract. A service has to |
| | | | | | be associated to a contract before a deal can |
| | | | | | be setup using that contract for that service. |

Deals
Subject Area

| | | | | | |
|---|---|---|---|---|---|
| 20.0 | RdealClass | 6 | SQL Server | Deals | This table is a reference table that indicates the |
| | | | | | types of deal class options that are available. |
| | | | | | The context of each class is 0 = Purchases, |
| | | | | | 1 = Sales and 2 = Both. The description field |
| | | | | | indicates the possible answers (but the |
| | | | | | rDealClassA table contains the actual answers |
| | | | | | that can be applied). |
| 21.0 | RdealClassA | 23 | SQL Server | Deals | This table is a reference table that indicates the |
| | | | | | possible deal classification options for each of |
| | | | | | the classifications defined in the rDealClass |
| | | | | | table. |
| 22.0 | RdealClassRules | 448 | SQL Server | Deals | This table contains record entries for every |
| | | | | | combination of deal classification answers |
| | | | | | (rDealClassA table). Each of these |
| | | | | | classification options can have its own set of |
| | | | | | calculation rules/etc associated with it. |
| 23.0 | Engine_Master | 39,149 | SQL Server | Deals | This table contains a record entry for each price |
| | | | | | entry effective date (header record). |
| 24.0 | Engine_MasterPrice | 79,244 | SQL Server | Deals | This particular table contains the individual |
| | | | | | pricing components associated to a given deal |
| | | | | | on a given effective date (parent record is on |
| | | | | | the Engine_Master table). When the user of |
| | | | | | the Energy Management System enters a |
| | | | | | price, this is the table that gets updated. |
| 25.0 | Package | 65,351 | SQL Server | Deals | This table contains a record for each deal that |
| | | | | | has been setup on the system. Start Date, End |
| | | | | | Date, Deal Name, Contract, Company, etc. are |
| | | | | | specified on this table. |
| 26.0 | PackageCosts | 381 | SQL Server | Deals | This table contains entries for all ‘other costs’ |
| | | | | | associated with a given deal. Each of these |
| | | | | | ‘other costs’ will have unique STID's (deal or |
| | | | | | meter level) and have calculated ‘Engine’ |
| | | | | | records automatically generated (when a |
| | | | | | calculation runs). |
| 27.0 | PackageCorrespondence | 3,447 | SQL Server | Deals | This table contains entries for all of the |
| | | | | | electronic correspondence between the parties |
| | | | | | to the deal (deal confirmations, availability |
| | | | | | reports, remittance detail, vouchers, etc.). |
| 28.0 | PriceComponents | 19 | SQL Server | Deals | This table contain record entries for each |
| | | | | | component that can be set aside for pricing |
| | | | | | purposes (on a deal). Examples include |
| | | | | | ‘DAILY INDEX’, ‘MONTHLY INDEX’, |
| | | | | | ‘GATHERING’, etc. These tags will be |
| | | | | | associated to each component of the price to |
| | | | | | allow for future queries and reporting. In |
| | | | | | addition, these tags will provide an audit trail of |
| | | | | | all pricing related information. |
| 29.0 | PriceDesc | 33,877 | SQL Server | Deals | This table contains a record for each deal |
| | | | | | description (or comments) within the system. |
| | | | | | These price description records (only 1 per |
| | | | | | deal) provide the users with a place to put free |
| | | | | | form text to help describe the price of the deal. |

Volume Inventory
Subject Area

| | | | | | |
|---|---|---|---|---|---|
| 30.0 | Engine | 280,970 | SQL Server | Volume | This table contains record entries for each |
| | | | | Inventory | calculated transaction that the system attaches |
| | | | | | to volume inventory items. Each transaction |
| | | | | | has a unique STID (transaction id) that are |
| | | | | | defined in the Engine_TransactionList table. |
| | | | | | Indicators on this table determine the |
| | | | | | disposition of the transaction. |
| 31.0 | Engine_TransactionList | 36 | SQL Server | Volume | This table contains record entries that define all |
| | | | | Inventory | of the transactions that can be calculated and |
| | | | | | stored in the Engine table. The STID field is |
| | | | | | the unique transaction identifier. |
| 32.0 | GasInv | 159,501 | SQL Server | Volume | This is the primary table were all volumes |
| | | | | Inventory | (nominated and actual) are maintained This |
| | | | | | table contains the header record entries that |
| | | | | | shows by month, company, transaction, |
| | | | | | pipe/field & meter/well the nominated volume |
| | | | | | and the estimated actual volumes. References |
| | | | | | to price types, contracts, etc. are stored on |
| | | | | | each record. |
| 33.0 | GasInvD | 4,145,617 | SQL Server | Volume | This table contains the detail (DAILY) |
| | | | | Inventory | nominated and estimated actual volumes for |
| | | | | | the GasInv table. |
| 34.0 | ProdInterest | 7,999 | SQL Server | Volume | This table contains a record that lists the |
| | | | | Inventory | production interests that are held for a given |
| | | | | | meter/well and contract (with date |
| | | | | | effectiveness). |
| 35.0 | ProdPkg | 4,080 | SQL Server | Volume | This table contains a record that indicates (by |
| | | | | Inventory | month) the contract and the deal ID of a deal |
| | | | | | that was generated automatically within the |
| | | | | | ‘Availability’ (equity purchase deal creation) |
| | | | | | area of the system. |
| 36.0 | ProdSum | 39,296 | SQL Server | Volume | This table contains records that indicate (by |
| | | | | Inventory | month and meter/well) the gross mmbtu's and |
| | | | | | the Btu factors. |
| 37.0 | ProdVol | 44,187 | SQL Server | Volume | This table contains record entries (by month |
| | | | | Inventory | and meter/well) which show the receipt and |
| | | | | | delivery mmbtu's per day. |

Operational
Subject Area

| | | | | | |
|---|---|---|---|---|---|
| 40 | ApplicationMessages | 55,882 | SQL Server | Operational | This table contains a ‘rolling’ 7 day listing of all |
| | | | | | application messages (such as those that are |
| | | | | | displayed to the console during a calculation). |
| 41.0 | ExceptionCategories | 8 | SQL Server | Operational | This table contains record entries to hold all of |
| | | | | | the exception ‘reasons’ that will be used |
| | | | | | whenever an exception even occurs. There |
| | | | | | can be multiple types of exception categories. |
| 42.0 | ExceptionList | 2,171 | SQL Server | Operational | This table contains entries for the actual |
| | | | | | exception events that get logged by the system. |
| | | | | | These represent an audit trail of non-normal or |
| | | | | | error type information. This table is linked to |
| | | | | | the ExceptionCategories table because each |
| | | | | | exception event (in this table) requires a reason |
| | | | | | category. |
| 43.0 | LogTable | 4 | SQL Server | Operational | This table is used for debugging purposes only |
| | | | | | and is not used in any screens or reports. |
| 44.0 | PrinterDef | 6 | SQL Server | Operational | This table contains a record for each available |
| | | | | | printer (including driver and port). |
| 45.0 | RgasMonth | 1,440 | SQL Server | Operational | This is a reference table that contains a record |
| | | | | | for each month from 1/1980 thru 12/2099. In |
| | | | | | addition, this table also contains the status and |
| | | | | | status update sequence number for the |
| | | | | | particular month. This status is used in order to |
| | | | | | enable/disable certain functions within the |
| | | | | | Energy Management System throughout the |
| | | | | | month. |
| 46.0 | RGasMonthStatus | 1,873 | SQL Server | Operational | This represents a historical audit table that will |
| | | | | | be updated every time the monthly status for a |
| | | | | | given production month is modified (via triggers |
| | | | | | on the RgasMonth table). This provides a |
| | | | | | mechanism of identifying who & when the |
| | | | | | changes were for the status, over time. |
| 47.0 | SEMessages | 1,251 | SQL Server | Operational | All system messages are stored in this table. |
| 48.0 | SEAudit | | SQL Server | Operational | This table contains record entries for those |
| | | | | | events that are deemed ‘auditable’. Some |
| | | | | | examples include ‘Login’ events, Actualization |
| | | | | | balancing events, standard report submission |
| | | | | | events, etc. |
| 49.0 | SEImages | 2 | SQL Server | Operational | This table contains record entries that contain |
| | | | | | graphic images for the screen and reports used |
| | | | | | throughout the system. |
| 50.0 | SELocations | 3 | SQL Server | Operational | This table contains record entries that define |
| | | | | | the server paths (network folder locations) |
| | | | | | where certain key correspondence items are |
| | | | | | found. For example (report location, deal |
| | | | | | correspondence, etc). |
| 51.0 | SEProcessingCodeTypes | 15 | SQL Server | Operational | This table contains the ‘Type’ codes to the |
| | | | | | reference table ‘SEProcessingCodes’. An |
| | | | | | example is the type code of ‘CONTRCTPRD’ |
| | | | | | which describes a reference code for contract |
| | | | | | products. |
| 52.0 | SEProcessingCodes | 143 | SQL Server | Operational | This table contains reference codes for various |
| | | | | | fields used throughout the Energy Management |
| | | | | | System. |
| 53.0 | SERptsExecutedStats | 19,117 | SQL Server | Operational | This table contains record entries that lists the |
| | | | | | start and end date and times for all reports that |
| | | | | | were submitted. This provides statistics on |
| | | | | | how long to execute/etc. |
| 54.0 | SERptsGroupItems | 218 | SQL Server | Operational | This table contains entries of each specific |
| | | | | | report that exists within a reporting tab (group) |
| | | | | | within a specific reporting folder (category). |
| 55.0 | SERptsGroups | 36 | SQL Server | Operational | This table contains a list of all available |
| | | | | | reporting tabs (groups) within each reporting |
| | | | | | folder (category). |
| 56.0 | SERptsItemDetail | 123 | SQL Server | Operational | This table contains the list of all available |
| | | | | | reports within the system. |
| 57.0 | SERptsItemParms | 657 | SQL Server | Operational | This table contains record entries for each |
| | | | | | report parameter for each report defined to the |
| | | | | | system. Options exist for substituting a |
| | | | | | different label name than actual parameter field |
| | | | | | name. |
| 58.0 | SERptsQueue | 5,667 | SQL Server | Operational | This table contains record entries for all |
| | | | | | ‘submitted’ reports (report queue). When |
| | | | | | reports are automatically removed from the |
| | | | | | system the record is removed from this queue. |
| 59.0 | SERptsQueueDistribute | 7,855 | SQL Server | Operational | This table contains entries that dictate how to |
| | | | | | distribute the output of reports from the queue |
| | | | | | (fax, email, printer, etc.). |
| 60.0 | SERptsQueueNotify | 276 | SQL Server | Operational | This table contains entries that indicate who |
| | | | | | (and if) individuals or groups have been notified |
| | | | | | that the report has finished. |
| 61.0 | SERptsSchedule | 0 | SQL Server | Operational | This table contains records that define specific |
| | | | | | schedules for the running of scheduled reports. |
| 62.0 | SERptsScheduledReports | 0 | SQL Server | Operational | This table contains record entries that define |
| | | | | | which reports to run as part of specific |
| | | | | | schedules. |
| 63.0 | SERptsScheduledGroups | 0 | SQL Server | Operational | This table contains ‘groups’ for scheduling. |
| | | | | | This provides the ability to assign multiple |
| | | | | | individuals to a specific group and have the |
| | | | | | group belong to the schedule. |
| 64.0 | SERptsScheduledUserGroup | 0 | SQL Server | Operational | This is the actual table that contains the |
| | | | | | members within a schedule group. Each entry |
| | | | | | in this table defines the group. |
| 65.0 | SERptsTablesUsed | 896 | SQL Server | Operational | This table contains documentation on what |
| | | | | | tables, views or stored procedures are used |
| | | | | | within each report. |

Pipes & Fields
Subject Area

| | | | | | |
|---|---|---|---|---|---|
| 80.0 | Meter | 4,335 | SQL Server | Pipes and | This table contains a record entry for each |
| | | | | Fields | well/meter that has been setup on the system. |
| | | | | | The pipe/field, name, county and state are |
| | | | | | stored here. |
| 81.0 | MeterNotes | 935 | SQL Server | Pipes and | This table contains a record for notes pertaining |
| | | | | Fields | to meters/wells. |
| 82.0 | PipeField | 372 | SQL Server | Pipes and | This table contains a record entry for each |
| | | | | Fields | pip/field defined on the system. The company |
| | | | | | and the pipe/field description are stored here. |
| 83.0 | MeterRates | 3,980 | SQL Server | Pipes and | This table contains the entire pressure base. |
| | | | | Fields | Btu factors by effective date for specific |
| | | | | | meters/wells. |
| 84.0 | MeterAllocations | 551 | SQL Server | Pipes and | This table contains entries for the allocation |
| | | | | Fields | information on the meter/well. This includes |
| | | | | | accounting cross-reference codes (id and |
| | | | | | deck). |

Pricing
Subject Area

| | | | | | |
|---|---|---|---|---|---|
| 90.0 | GCIndex | 142,268 | SQL Server | Pricing | This table contains record entries by Day for |
| | | | | | daily index prices AND/OR a single entry for |
| | | | | | monthly index prices (1^{st} day of month for |
| | | | | | monthly indices). |
| 91.0 | IndexRef | 228 | SQL Server | Pricing | This represents the master table of all defined |
| | | | | | price indices within the Energy Management |
| | | | | | System. One record entry per index exists |
| | | | | | within this table. |
| 92.0 | IndexBaskets | 14 | SQL Server | Pricing | This table contains a record entry for each |
| | | | | | index basket established on the system. These |
| | | | | | index baskets can be associated to sales or |
| | | | | | purchase deals just as normal indexes are |
| | | | | | associated to them. Simple averages are |
| | | | | | calculated with all index items within an index |
| | | | | | basket. |
| 93.0 | IndexBasketLink | 36 | SQL Server | Pricing | This table contains the actual indices that are |
| | | | | | currently associated with an index basket. An |
| | | | | | unlimited number of indices can exist in a |
| | | | | | basket. A simple average of all the prices |
| | | | | | within the basket is used. |

Routing
Subject Area

| | | | | | |
|---|---|---|---|---|---|
| 101.0 | LegRef | 4,226 | SQL Server | Routing | This table contains record for each unique |
| | | | | | transportation leg (meter-to-meter) on the |
| | | | | | Energy Management System. |
| 102.0 | Leg | 57,830 | SQL Server | Routing | This table contains a record for each active leg |
| | | | | | within a given month. Nomination and actual |
| | | | | | rates that the leg utilizes during the month are |
| | | | | | posted on each record. These rates are used |
| | | | | | with the actual routing instructions (LegDetail |
| | | | | | table). |
| 103.0 | LegD | 0 | SQL Server | Routing | This table contains OPTIONAL entries for any |
| | | | | | daily leg rates that need to be utilized within a |
| | | | | | given month. Daily rates are checked PRIOR |
| | | | | | to the monthly rates (on the Leg table) when |
| | | | | | setting up the actual routing instructions |
| | | | | | (LegDetail table). |
| 104.0 | LegDetail | 1,716,695 | SQL Server | Routing | This table contains the detail routing |
| | | | | | instructions for all volumes purchased all the |
| | | | | | way through the sales points for that particular |
| | | | | | volume. Nomination AND actual routing |
| | | | | | instructions are stored for each meter/well that |
| | | | | | had volume activity during the month. All |
| | | | | | volumes sold can be tracked back to originating |
| | | | | | purchase points. |
| 105.0 | WASPResovedRouting | 34,304 | SQL Server | Routing | This table contains record entries that show the |
| | | | | | pool level calculated totals for all receipt and |
| | | | | | delivery points within the system. ‘Common’, |
| | | | | | ‘Dedicated’ and ‘None’ pools are aggregated |
| | | | | | and the total numbers stored here. Only |
| | | | | | ‘Common’ pool volumes and dollars represent |
| | | | | | the totals from more than one purchase point |
| | | | | | (shows weighted average pricing based on |
| | | | | | volumes purchased and/or transported). |

Security
Subject Area

| | | | | | |
|---|---|---|---|---|---|
| 110.0 | GCUser | 27 | SQL Server | Security | This table contains a single record entry per |
| | | | | | unique user (employee) on the system. The |
| | | | | | character based (up to 12 character) login ID |
| | | | | | AND an internal user id (integer) are unique |
| | | | | | keys to this table. |
| 111.0 | GCButton | 58 | SQL Server | Security | This table contains records that represent the |
| | | | | | system functions that have specific security |
| | | | | | rules associated with them on the system. For |
| | | | | | example a system function of ‘DEALS’ has |
| | | | | | been setup in order to define security |
| | | | | | relationships between users (GCUser table) |
| | | | | | and this function. |
| 112.0 | GCSecurity | 1,548 | SQL Server | Security | This table stores the relationships between |
| | | | | | users on the system (GCUser table) and the |
| | | | | | system function that they have access too |
| | | | | | (GCButton table). A specific access privilege is |
| | | | | | stored for each of these relationships (like |
| | | | | | READ ONLY, READ/UPDATE, |
| | | | | | READ/UPDATE/DELETE or SUPER). |

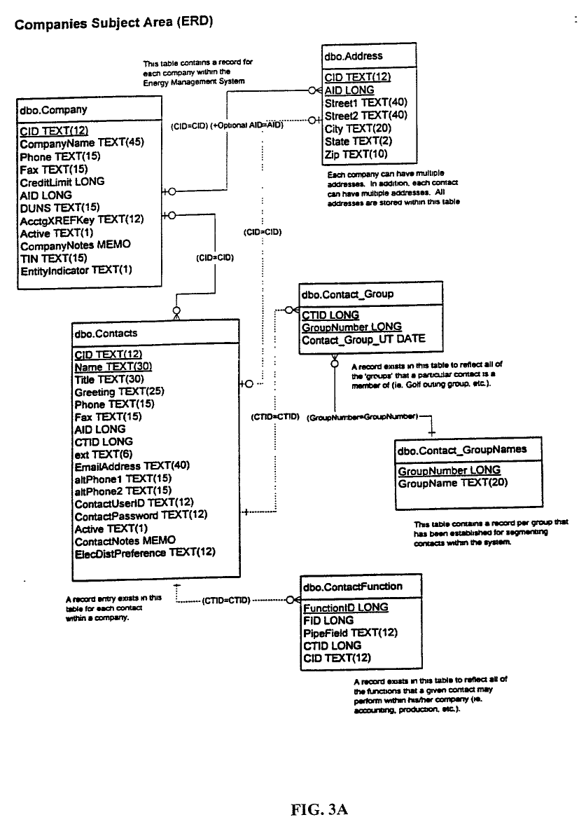

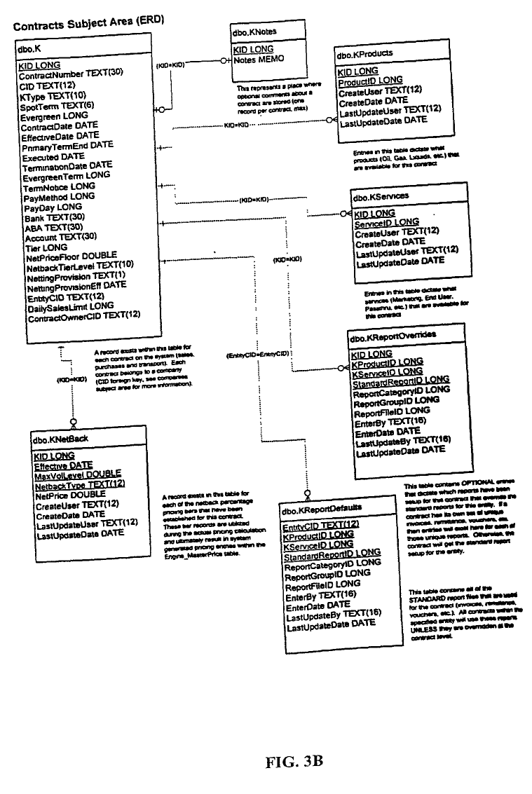

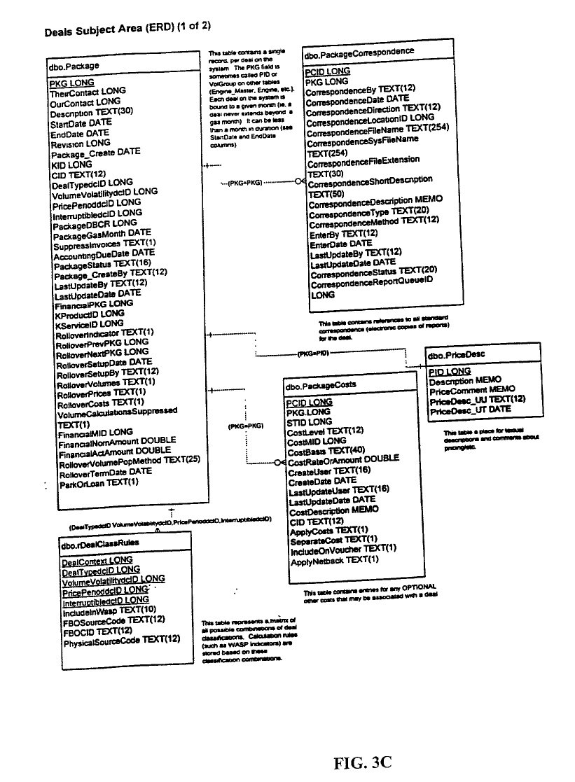

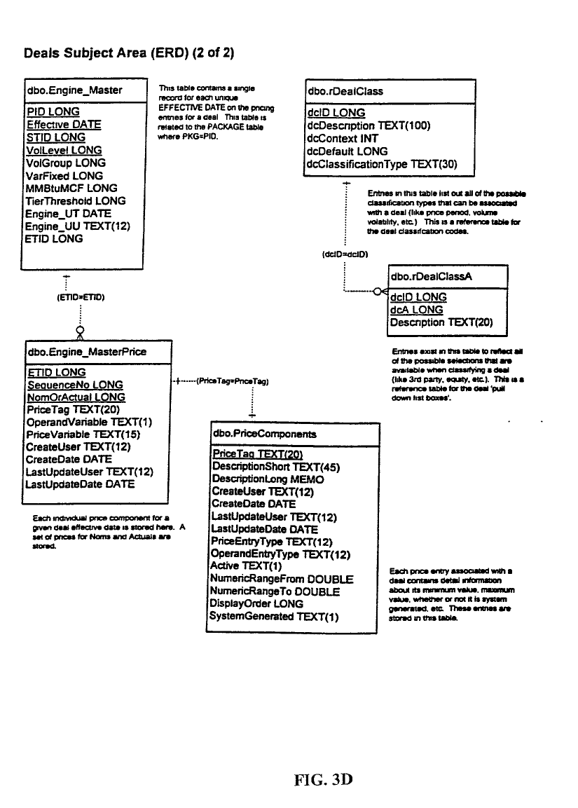

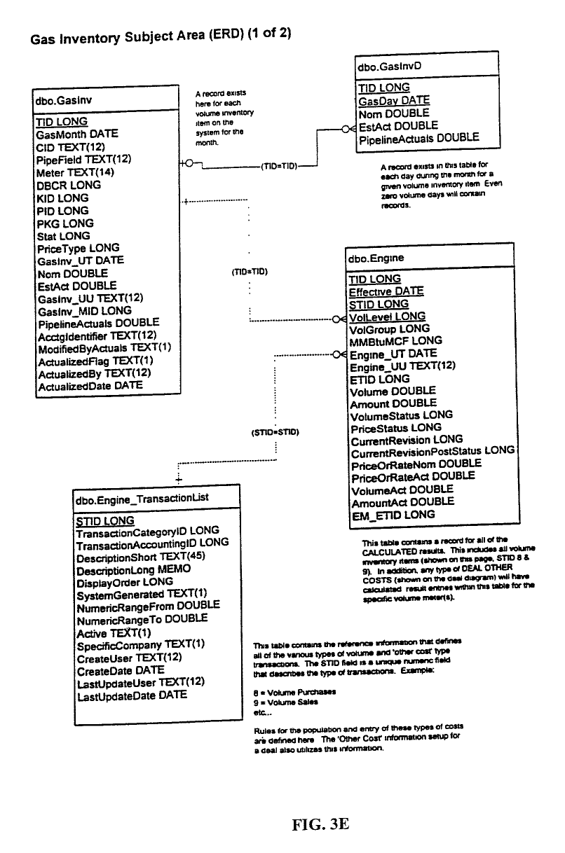

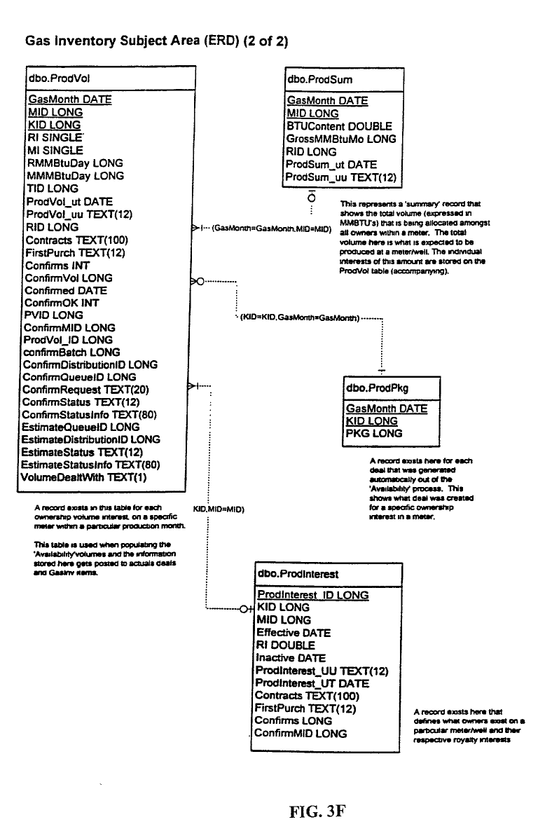

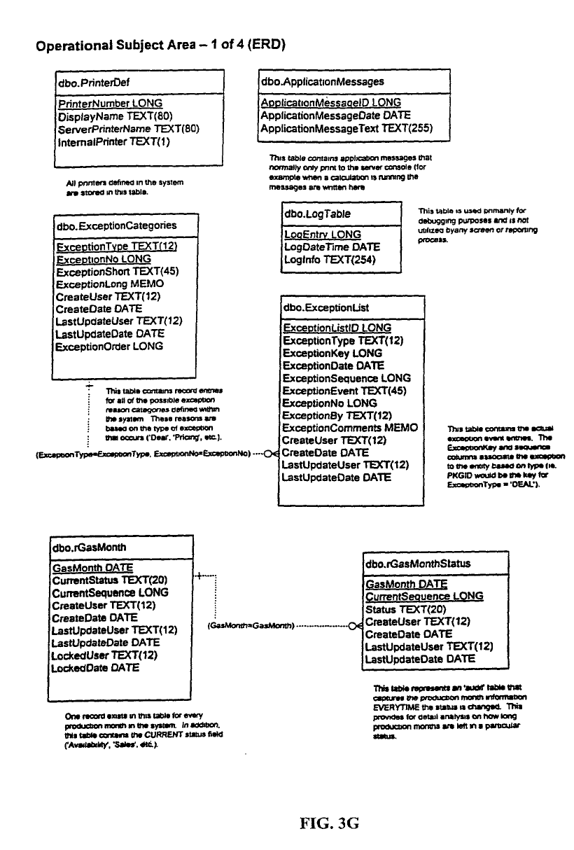

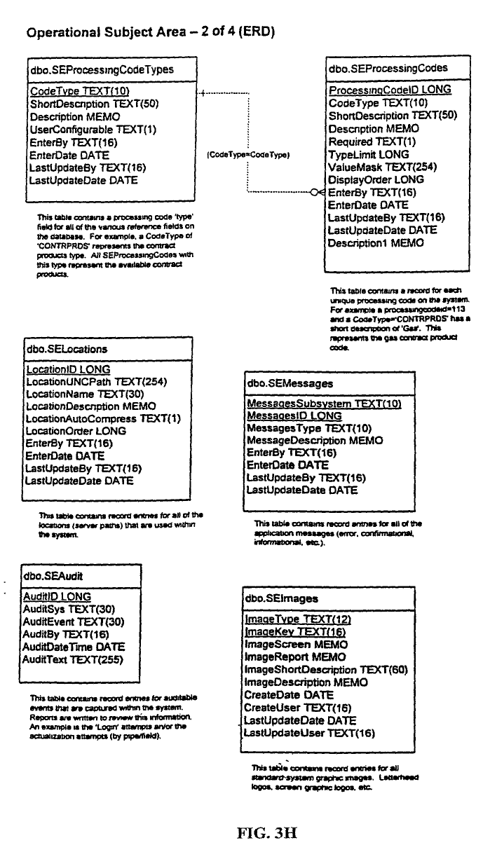

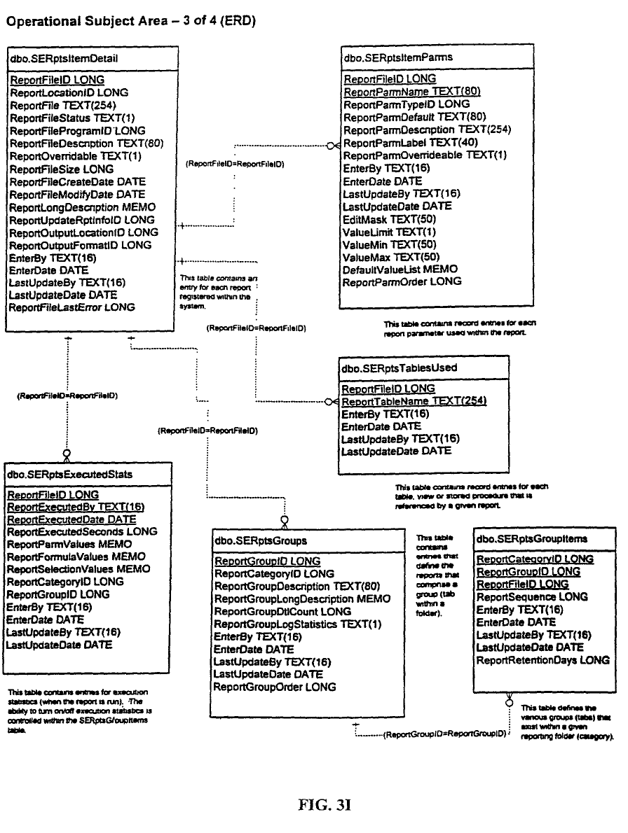

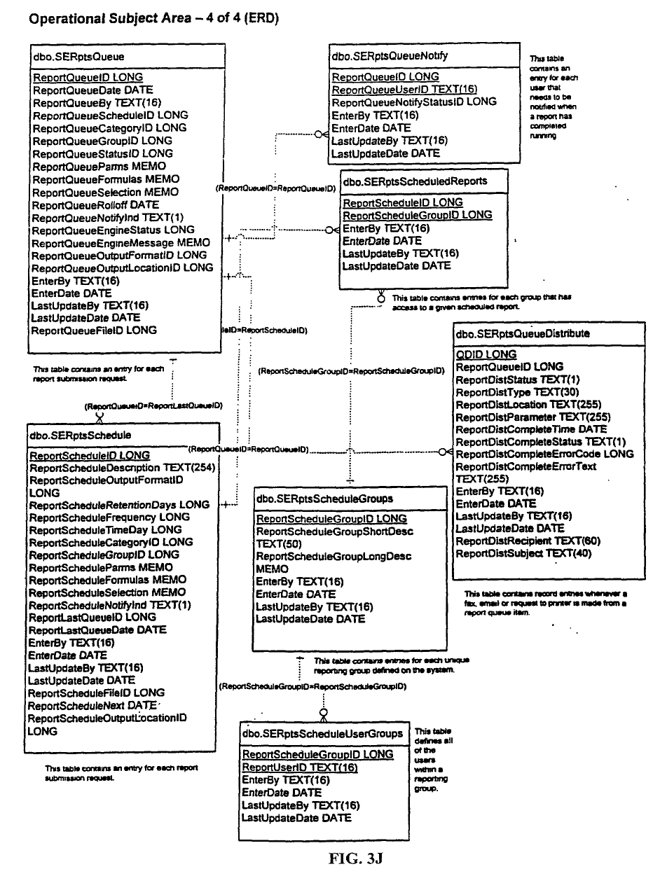

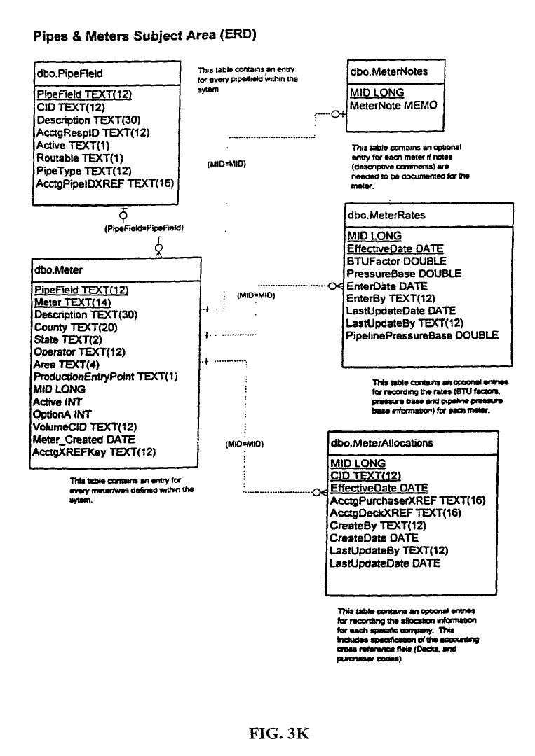

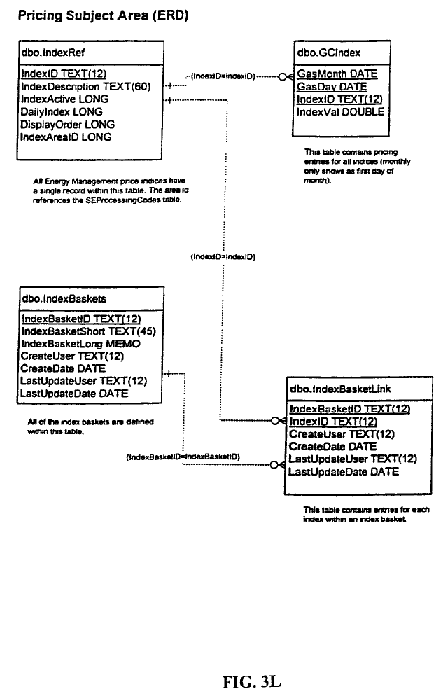

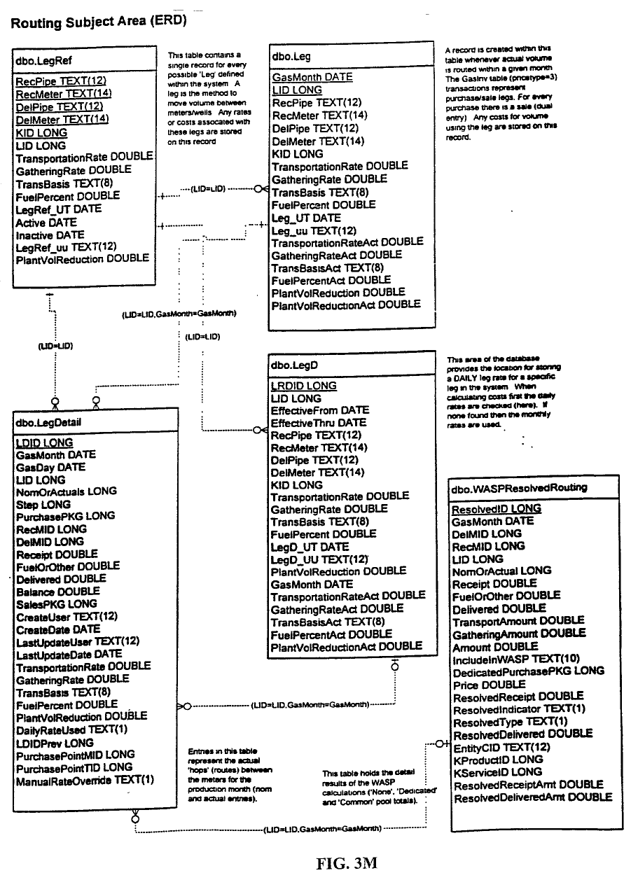

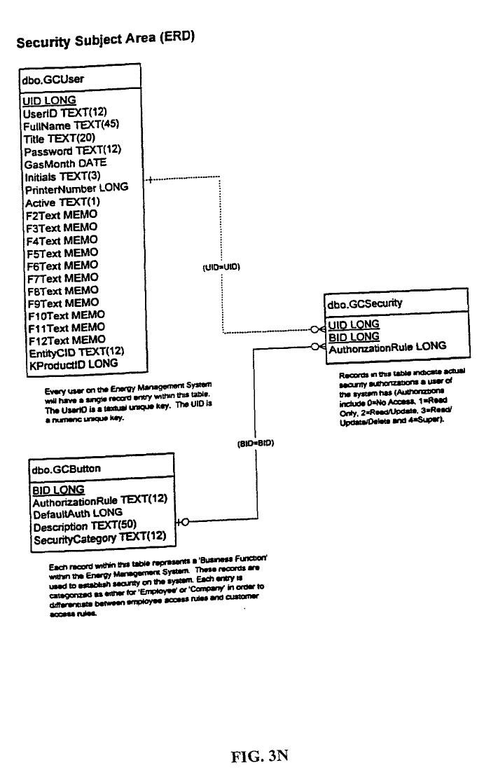

Referring now to FIGS. 3A-3N, depicted therein are entity relationship diagrams that illustrate data relationships among tables and corresponding table entries used to implement the systems and methods that carry out the business process illustrated in FIG. 1. The database tables used logically categorized above into the above-identified nine (9) subject areas are maintained within data store 106 (FIG. 1), and are included among the files present on the attached compact disc, and are further defined in detail in FIGS. 3A-3N. Those skilled in the art will readily understand the data relationships among relational database tables as shown in FIGS. 3A-3N. Accordingly, for purposes of brevity, further comments about FIGS. 3A-3N have been omitted.

In addition to the tables described and specified in the tables listed above, the following table illustrates an inventory of the various database views that utilized by the systems and methods provided by the present invention.

View Descriptions

Below is an inventory of the various database views that are utilized by the Energy Management System:

| Ref # | View Name | Description/Comments |
|---|---|---|
| 1.0 | V_SearchDB | Provides a view to search the database stored procedures and triggers for specific text items. |
| | | Used for assessing the impact of system changes. |
| 2.0 | VAccountingRevenueFeed | Database view (3 select UNION) used for creating OGSYS journal and revenue receivable data. |
| 3.0 | VCompany | Display of company information (name, address, etc.) |
| 4.0 | Vcontact_Accounting | Display the accounting contact for a given company. |
| 5.0 | Vcontact_Admin | Display the administrative contact for a given company. |
| 6.0 | Vcontact_Control | Display the control contact for a given company. |
| 7.0 | Vcontact_Production | Display the production contact for a given company. This is the contact used for-Availability |
| | | estimates/etc. |
| 8.0 | Vcontact_volconfirm | Display the contact responsible for confirming volumes within a given company. This is the |
| | | contact used for volume confirmations in the ‘Availability’ phase. |
| 9.0 | VcontactFunction | Display a list of all contacts for a given company along with their respective functions (accounting, |
| | | volume confirmations, etc.) |
| 10.0 | VContacts | Display name and addresses for contacts. |
| 11.0 | VETID_Dates | Display the engine start, effective and end dates for a given engine transaction id (based on |
| | | package). This view is used VERY LITTLE because of performance issues. |
| 16.0 | VgasInvD_NomChg | Display list of daily volumes where the nomination volumes are different between two successive |
| | | days. |
| 17.0 | VKTermination | Displays specific contract termination information. |
| 18.0 | VlegDetail_MeterTotals | Display routing information summarized by meter. |
| 19.0 | VlegDetail_PipelineComparison | Display routing information in a format that is used for the pipe/field comparison report. Used for |
| | | reconciling fuel, gathering, transport, pvr, etc to pipe/field statements. |
| 20.0 | VlegDetail_PurchasePointTotals | Display routing information that shows total routing costs/etc for given purchase points (hop 0's). |
| 21.0 | VlegDetail_Summary | Displays routing information (summarized) for reporting purposes (purchase meters/wells only). |
| 22.0 | VlegDetail_SummarySales | Displays routing information (summarized) for reporting purposes (sales meters/wells only). |
| 23.0 | VMeterAllocations | This view is used to list the current meter/well allocations (based on effective date) for each given |
| | | meter/well. These allocations are the accounting deck and purchaser id information, which can be |
| | | different from month to month. |
| 24.0 | VMeterRates | This view is used to list the current meter/well rates (standard pressure base, pipe/field pressure |
| | | base, Btu factor, etc.) for each given meter/well. These rates can be different from month to |
| | | month. |
| 25.0 | VOurContact_Accting | Display the current HEC contact for accounting information. |
| 26.0 | VOurContact_Prod | Display the current HEC contact for production information. |
| 27.0 | VPackage_Info | Display detail list of information concerning a package (includes contacts, names, phones, etc.). |
| 28.0 | VPrevGasMonthStuff | Displays current month volume totals versus previous month volume totals. |
| 29.0 | VprodConfirmLetters | Display contact information for use with correspondence on production volumes. Specifically used |
| | | in the confirmation process in the ‘Availability’ production month phase. |
| 30.0 | VprodInterest | Display a list of contracts and meters to confirm the production interests. This is used primarily in |
| | | the ‘Availability’ production month phase. |
| 31.0 | VRequestProduction | Display list of production interest volume and meter information. This is used primarily in the |
| | | ‘Availability’ production month phase and is used when sending out estimate reports to producers. |

Once all software and data as described above has been properly installed on one or more server systems 102 and within one or more coupled (networked) client systems 104 as illustrated in FIG. 1, use and operation of the systems and methods provided by the present invention may be commenced. Such operations may be in relation to the general use application (Energy Management System—EMS) or the limited use/user/function application (Producer Control Console—PCC) provided on the attached compact disc. In either case, the present invention facilitates a client-server application environment that includes, among other things, a user interface that is pleasing to users and which permits easy and ready access to system functions and operations. Such a user interface may be a graphical user interface or GUI that is configured to permit a user to engage in window-operations to bring about database operations that affect fuel deal data and the like in accordance with the present invention. Such a GUI is illustrated by way of screen shots (images of computer monitor screens) that are used to permit generation of, manipulation of, reporting of , and all other system operations relating to fuel deals and corresponding fuel deal data.

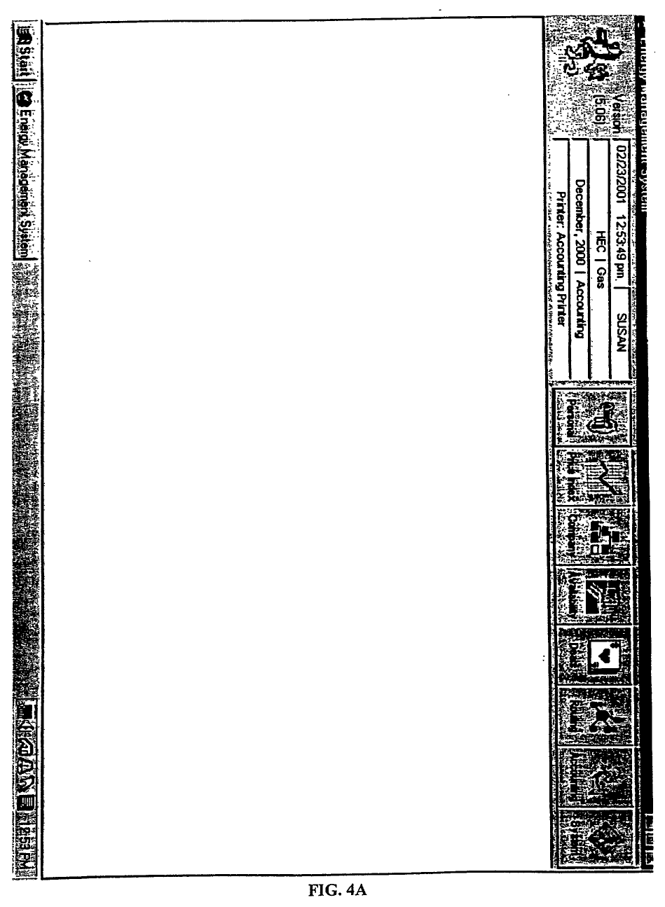

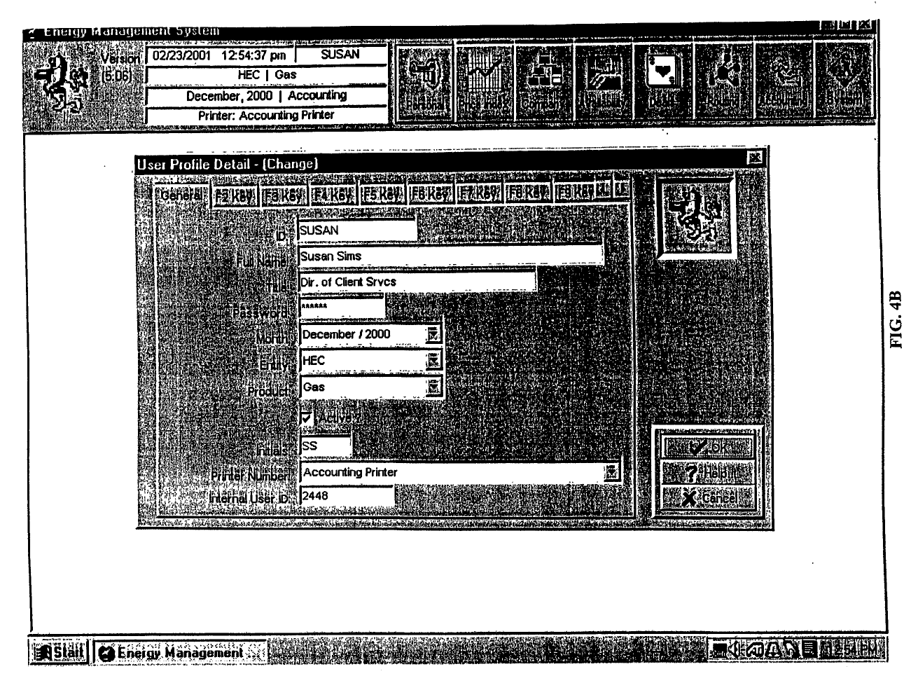

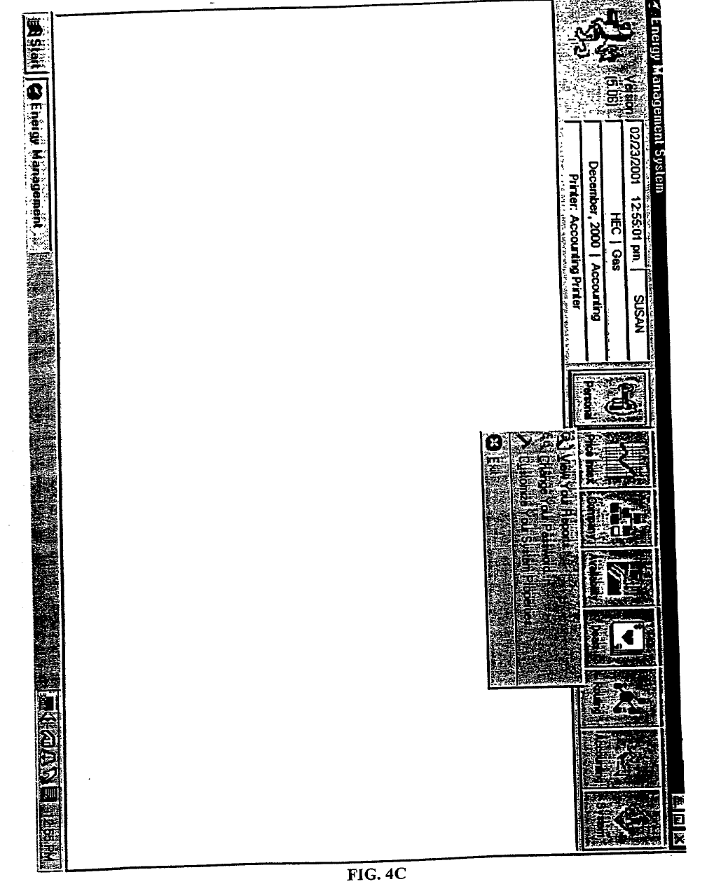

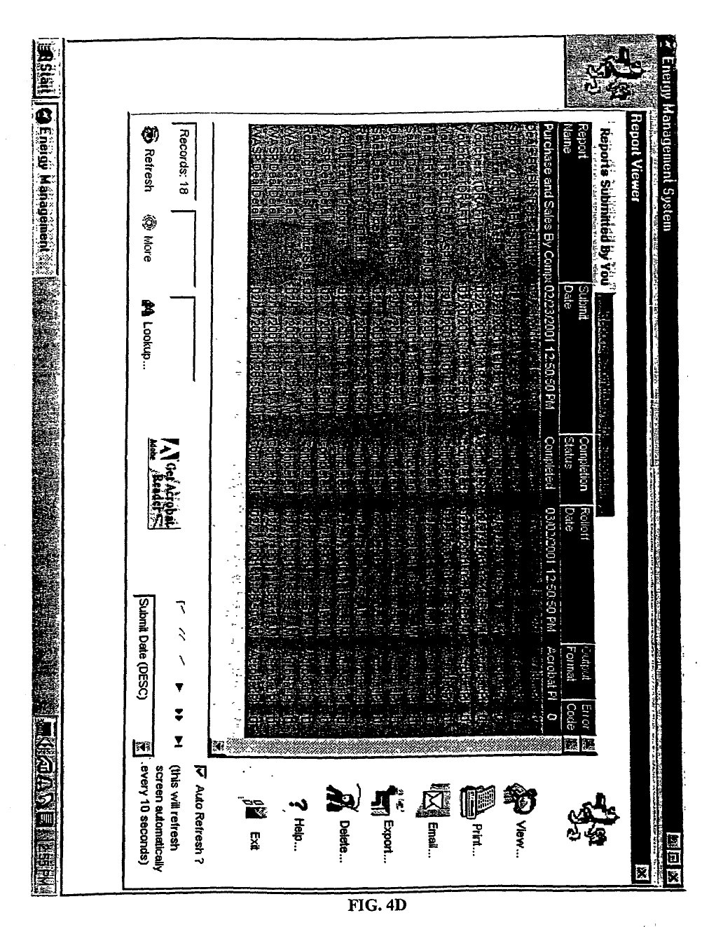

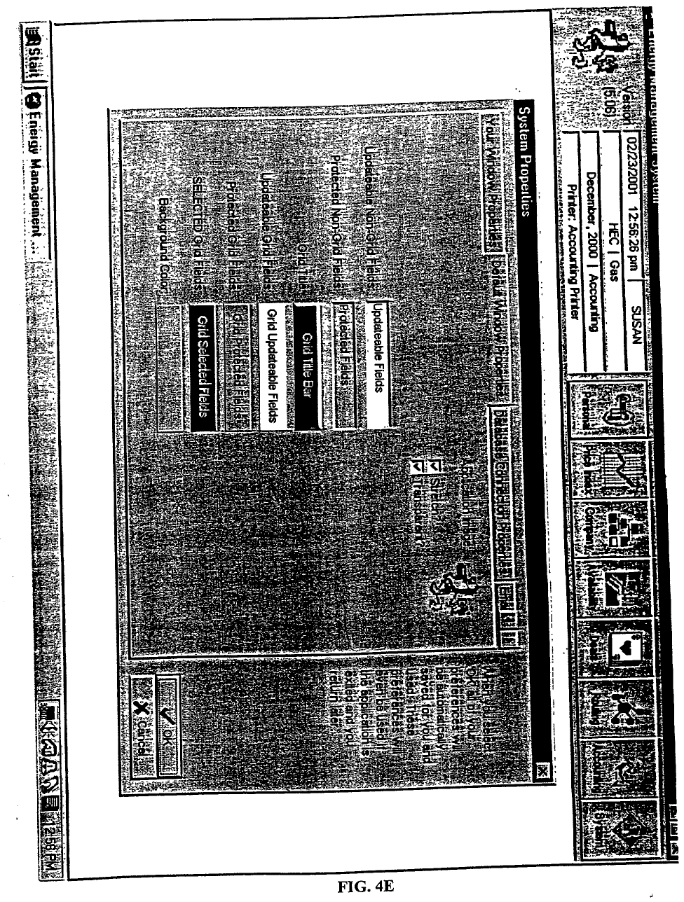

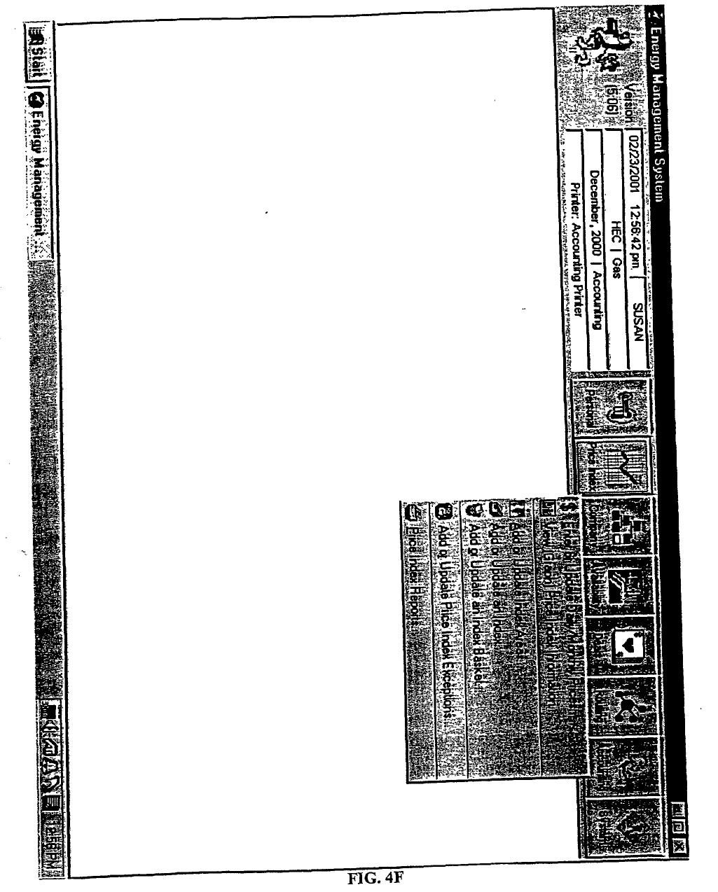

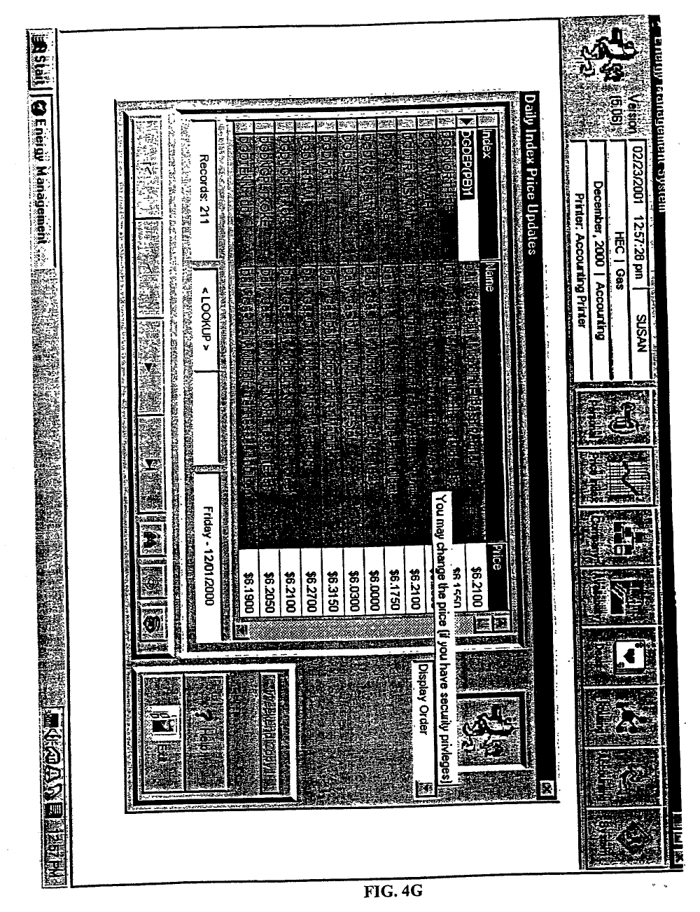

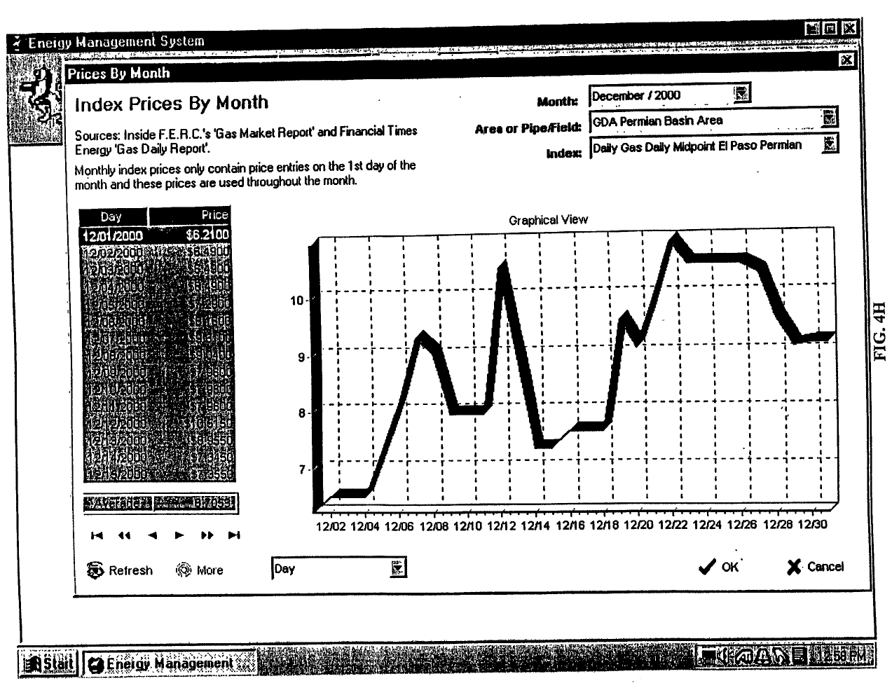

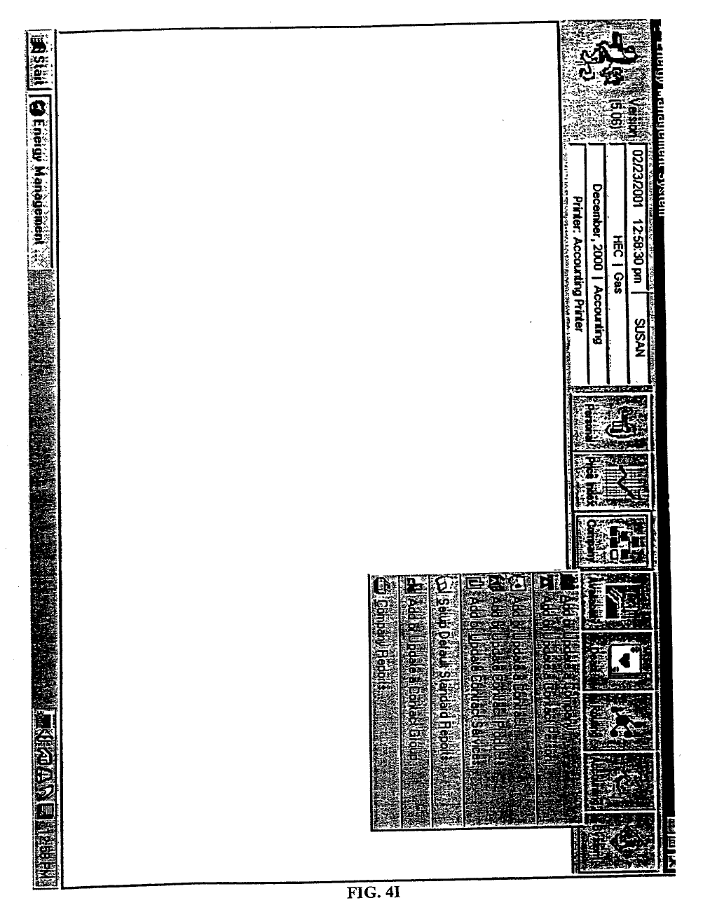

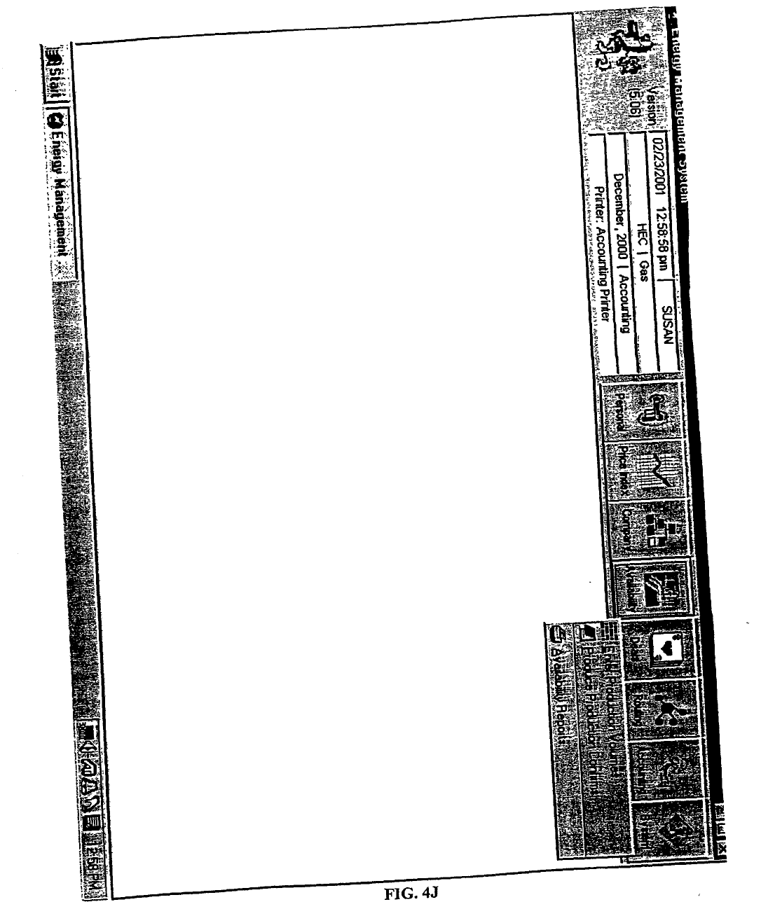

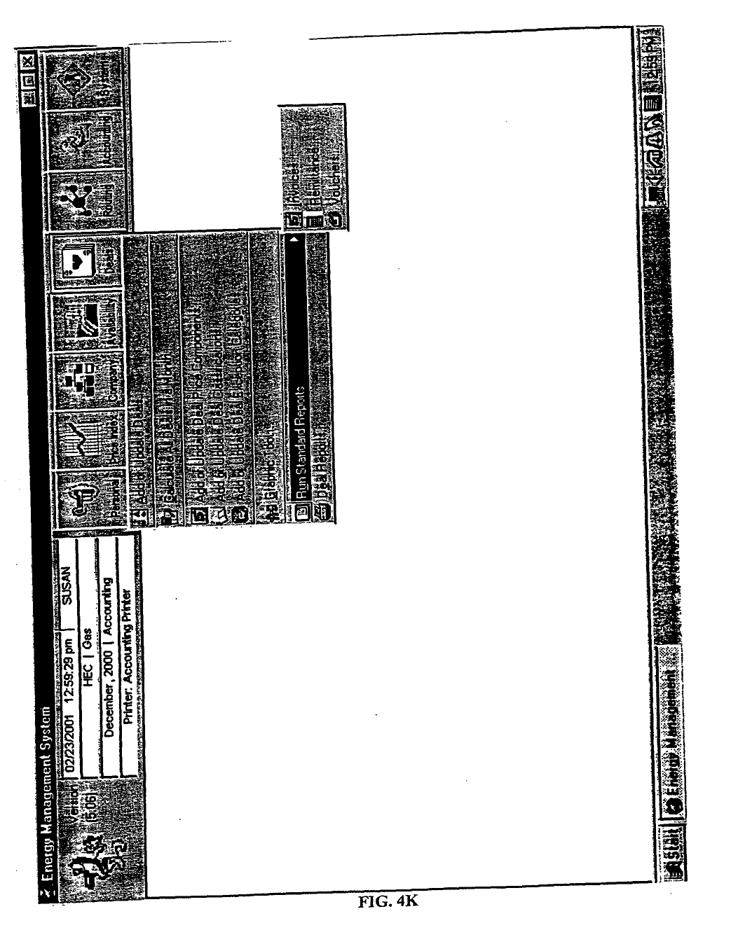

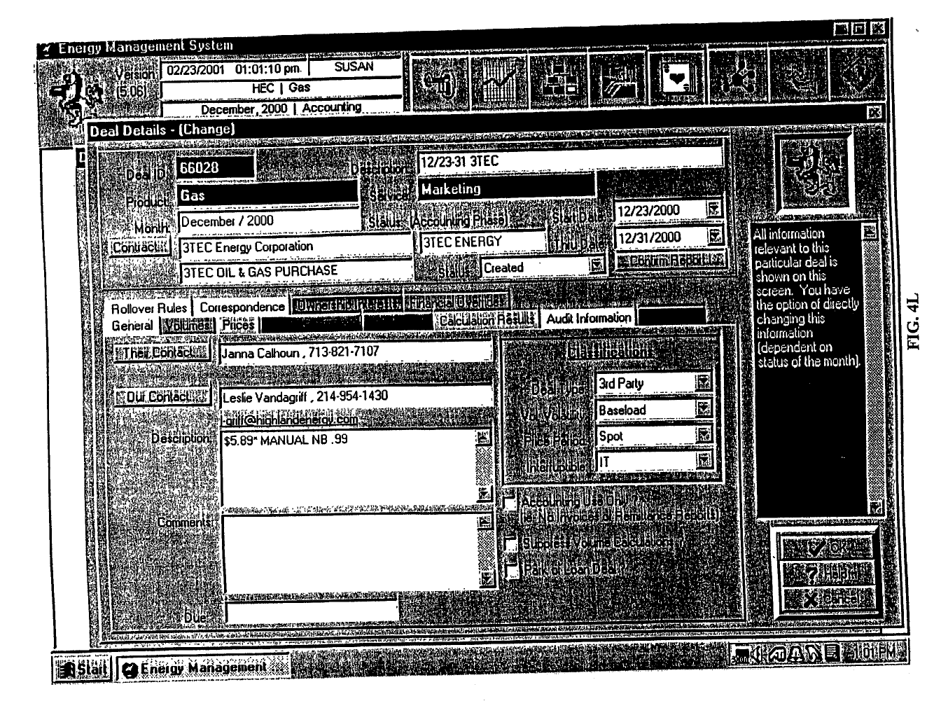

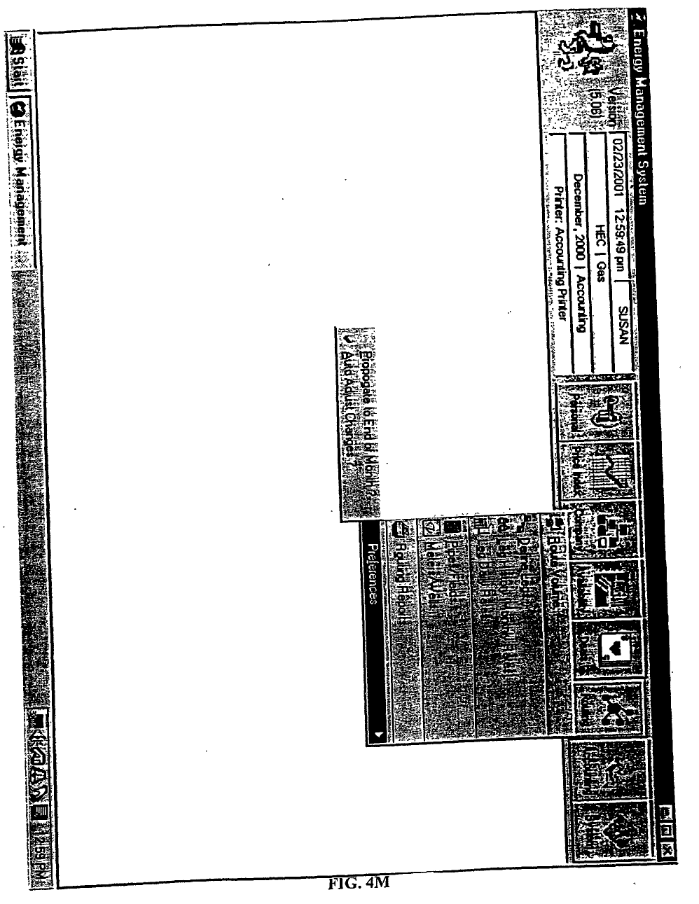

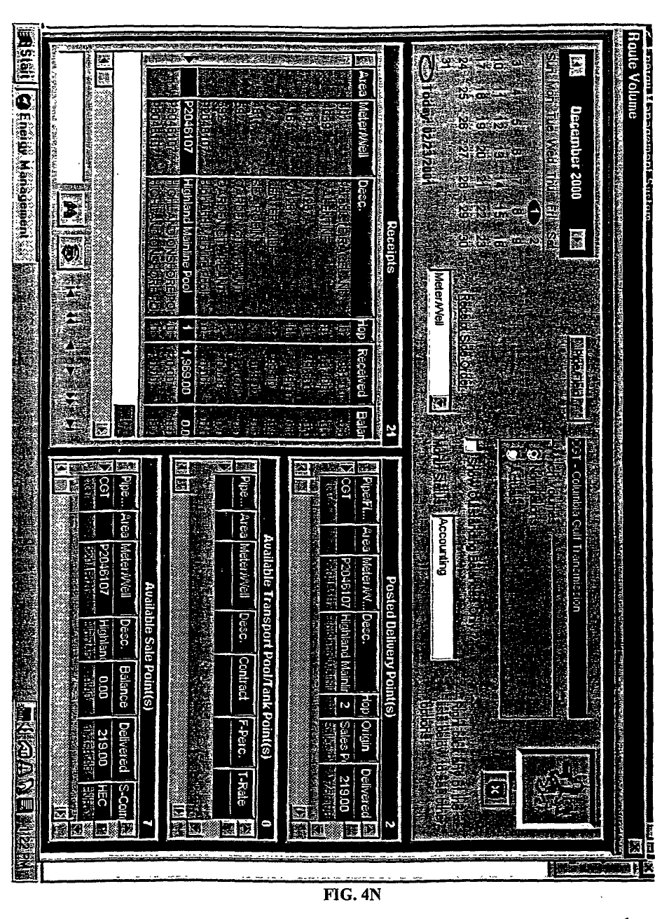

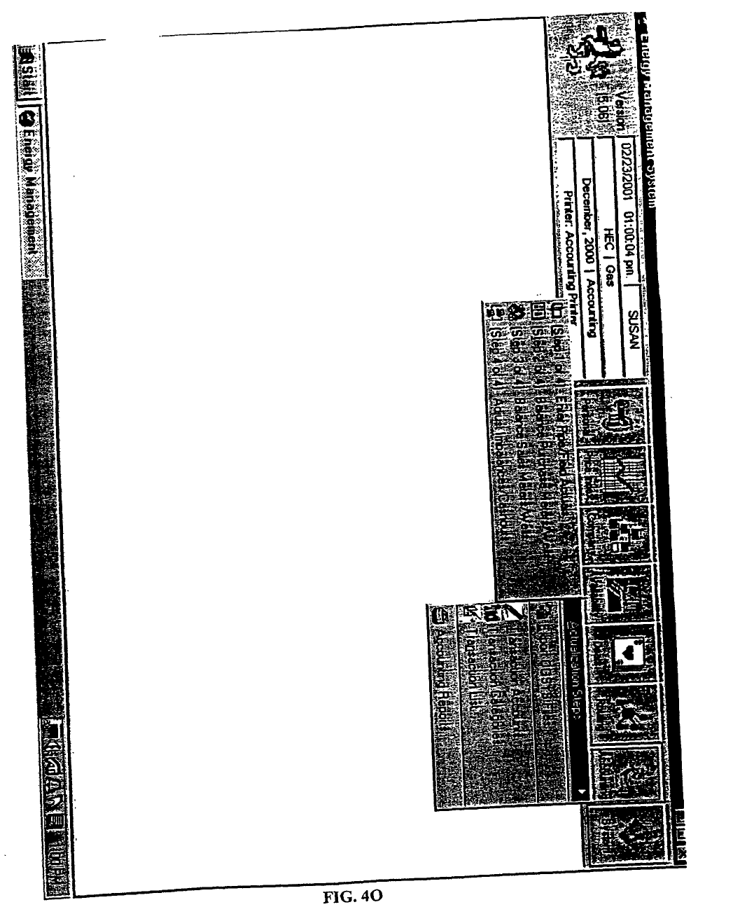

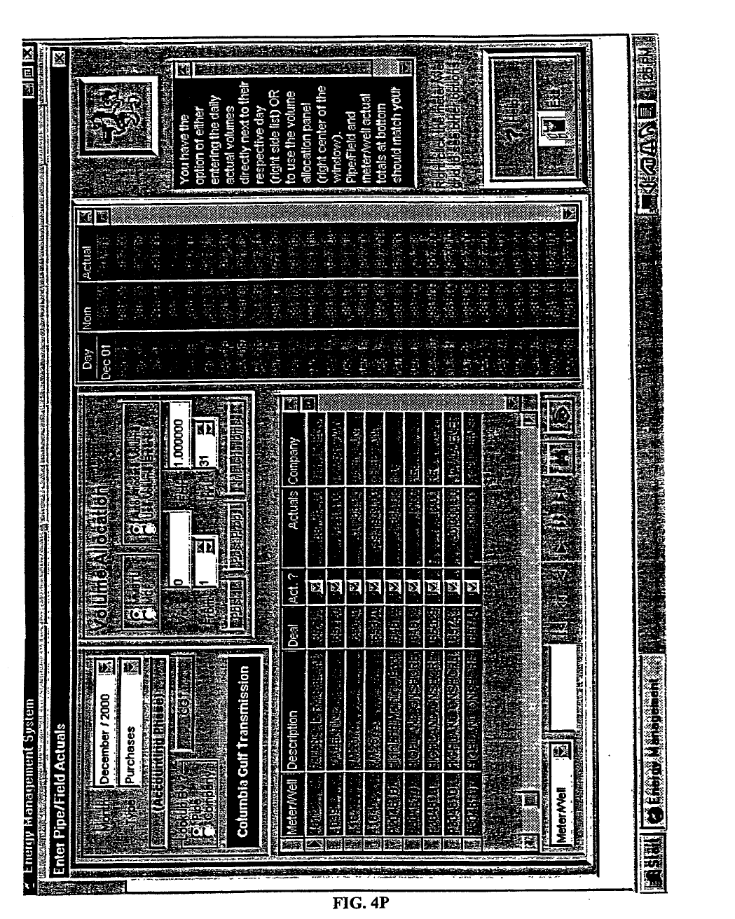

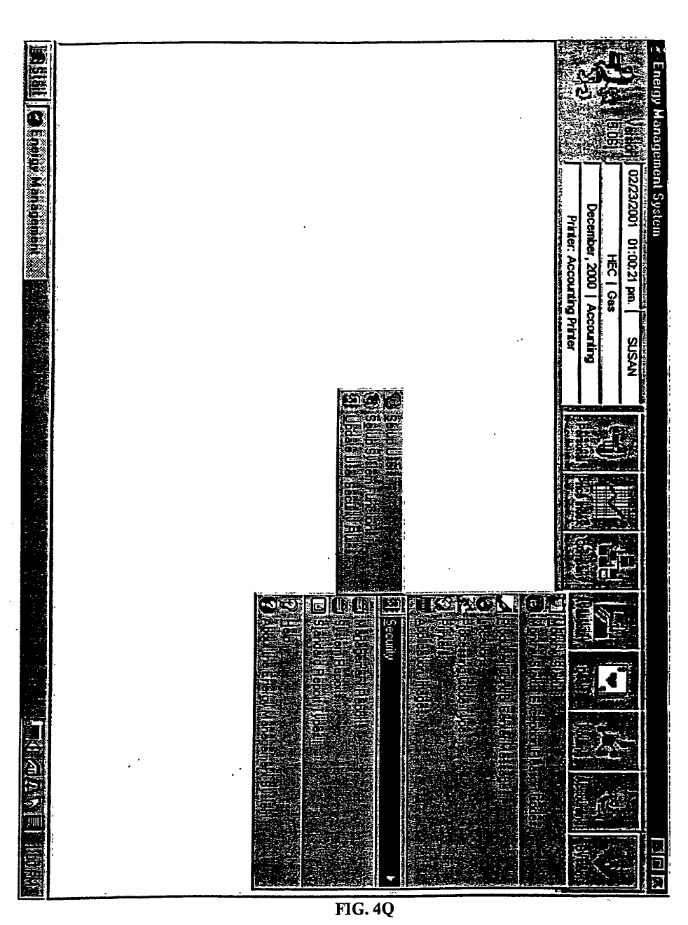

For example, reference is now made to FIGS. 4A-4Q which illustrate a data processing application running within a client system to facilitate at least some of the operations carried out to effect the business process illustrated in FIG. 1. FIG. 1, for example, represents an opening main menu screen through which a user may select “PERSONAL” operations related to setting up a personal profile to affect user-preferred presentation of data (e.g., name, screen colors, etc.). Additionally, a user may select “PRICE-INDEX” to affect fuel pricing and index related data. A user may select “COMPANY” to control lists of producers, and other related company entities. A user may select other options corresponding to the steps involved and described with regard to the MONTH OF FLOW PROCESS illustrated and described with reference to FIG. 1.

The other screen shots shown in FIGS. 4B-4Q further illustrate specific features of the GUI that has been designed to facilitate the implementation of the systems and methods provided by the present invention. For the purpose brevity, further detailed comments related to such screen shots has been omitted.

### SYSTEM IMPLEMENTATION AND FUNCTIONALITY

As noted above, the present invention utilizes stored procedures in the form of database management system procedures and functions which are executed server-side and client-side to facilitate the present invention's systems and methods. Listed in the following tables, is a detailed break-down of all the stored procedures, tools, and modules used to facilitate such systems and methods. The actual source code and instructions contained with in such procedures, functions, and modules is contained on the attached compact disc.

### STORED PROCEDURES

Below is an inventory of the various database-stored procedures (procedures and functions) that are utilized by the systems and methods provided by the present invention. Each of the stored procedures and functions are written in the Transact-SQL dialect. All of the stored procedures are prefixed with “usp_” which stands for “User Stored Procedure.” This provides an ability to differentiate those procedures bundled with the DBMS versus those created for the systems and methods provided by the present invention:

Stored Procedures

Below is an inventory of the various database-stored procedures (procedures and functions) that are utilized by the Energy Management System. Each of these stored procedures and functions are written in the Transact-SQL dialect. All of the stored procedures are prefixed with “usp_” which stands for “User Stored Procedures”. This provides an ability to differentiate those bundled with the DBMS versus those specifically created for the EMS application.

| Ref # | Stored Procedure Name | Description/Comments |
|---|---|---|
| 1.0 | Usp_DailyCleanup | This procedure is run everyday and is responsible for any cleanup activities (like |
| | | rolling aged messages off the ApplicationMessages table). |
| 2.0 | Usp_fGetCalcIndex | Retrieves the weighted average price for a given volume item. This routine is |
| | | invoked during the WASP calculation in order to obtain the price for the |
| | | meter/well and post it to the Engine database table. |
| 3.0 | Usp_fGetIndex | Retrieves the daily or monthly price index for a given day. Used during the |
| | | pricing calculation routine. |
| 4.0 | Usp_fGetIndexBasket | Retrieves and calculates the index amounts for the price lines whenever an |
| | | index basket price variable has been entered. This particular function will return |
| | | the average price (simple average) of all indices within the basket for a given |
| | | month/day. |
| 5.0 | Usp_fGetNetbackPercentage | This function will return the actual netback percentage to be used for a given |
| | | production month and contract. When it calculates the netback it looks at |
| | | volumes and tier instructions that have been setup on the contract. The number |
| | | it returns is the netback percentage to utilize. In addition, this routine brings |
| | | back the specific percentage to use for the product being calculated (gas, |
| | | liquids, oil, etc.). |
| 6.0 | Usp_fGetProdInterestID | This routine brings back the production interest information for a particular |
| | | ownership interest. |
| 7.0 | Usp_fGetProdPkg | This procedure brings back the ‘deal id’ (if one already exists) when posting |
| | | volumes through the ‘Availability’ screens. If a deal does not already exist (in the |
| | | current production month) then a new deal is created and that ID is sent back. |
| 8.0 | Usp_fGetWASPIndicator | This function accepts a deal id (package ID) as it's input. It then reads the |
| | | DealClass table and the rDealClass table(s) to determine if this particular deal |
| | | should be considered WASPable based on its classification scheme. The return |
| | | values are either ‘None’, ‘Common’ or ‘Dedicated’. |
| 9.0 | Usp_fGetwaspType | This procedure will send back the WASP type field (GAS, OIL or LIQUIDS) when |
| | | passed a specific product ID. This procedure is used during the calculation in |
| | | order to determine which set of netback rules off a contract to use. |
| 10.0 | Usp_flsLastDay | This procedure accepts a date and sends back the last date in a production |
| | | month. |
| 11.0 | Usp_fLastDay | This procedure accepts a date and sends back the last date in a production |
| | | month. |
| 12.0 | Usp_fPipeContactInfo | This procedure, when passed a pipe/field id, will send back the specific contact |
| | | information requested (like accounting contact, volume contact, etc.). |
| 13.0 | USP_GasDayToGasMonth | This function will return the production month to use for a given production day. |
| 14.0 | Usp_GetproductVolumeRound | This routine will return the rounding precision necessary when calculating |
| | | volume information for specify products (Oil calculates to 2 decimal places. Gas |
| | | to zero, etc). |
| 15.0 | Usp_LinePrice | This is the actual procedure that will calculate the Engine records for a given |
| | | deal (volume related STID 8 or 9 type records). |
| 16.0 | Usp_message | This routine handles all of the ‘progress’ messages that are issued during the |
| | | calculation, rollover, actualization, and etc. type events on the system. This |
| | | routine will optionally post this information to the ApplicationMessages table for |
| | | historical reference (audit). |
| 17.0 | Usp_pActualize_BalPurchases | This is the main driver routine for Step 2 of 4 of the actualization process. |
| 18.0 | Usp_pActualize_BalPurchasesCheck | This routine will check to see if all of the meters/wells on a given pipe/field have |
| | | been actualized. If not, then it sends back a bad return code. All meters/wells |
| | | are required to be ‘checked’ (actualized) prior to balancing of purchase routing |
| | | points |
| 19.0 | Usp_pActualize_BalPurchasesClear | This routine is the actual routine that will adjust all purchase meter imbalances. |
| | | These imbalances are adjusted forward THROUGH the sales point based on |
| | | nomination routing instructions (used as a map). |
| 20.0 | Usp_pActualize_BalSales | This is the main driver routine for Step 3 of 4 of the actualization process. |
| 21.0 | Usp_pActualize_BalSalesCheck | This routine will check to see if all of the purchase meters/wells routing balances |
| | | (from step 2 of 4) are balanced. If any meter/well on the pipe/field is out of |
| | | balance then this routine sends back a bad return code. All meters/wells on the |
| | | pipe/field are required to be ‘balanced’ prior to balancing of the sales points. |
| 22.0 | Usp_pActualize_BalSalesClear | This procedure is the final procedure invoked by the usp_pActualize_BalSales |
| | | main driver procedure. It is responsible for posting imbalance amounts to the |
| | | internal clearing purchase or sales deals. |
| 23.0 | Usp_pActualize_BalSalesClear | This procedure attempts to reconcile any outstanding balances that result in |
| | | OVER supplying of volume to a particular sale. Nomination information is used |
| | | by this routine as a ‘road map’ on how to allocate this volume. |
| 24.0 | Usp_pActualize_BalSalesUnder | This procedure attempts to reconcile any outstanding balances that result in |
| | | UNDER supplying of volume to a particular sale. Nomination information is used |
| | | by this routine as a ‘road map’ on how to allocate this volume. |
| 25.0 | Usp_pFillIndex | This procedure will initialize the records within the ‘GCIndex’ table with daily |
| | | entries (for daily indices) and monthly entries (for monthly indices). The monthly |
| | | record entries are only on the first day of the month. |
| 26.0 | Usp_FillIndexSingle | This procedure will populate the ‘GCIndex’ table with a price index entry for a |
| | | SINGLE index. |
| 27.0 | Usp_pGasInvD_Fill | This routine initially populates the daily volumes on the GasInvD table. These |
| | | are initially populated with zeros (anytime a meter/well is added to a deal). |
| 28.0 | Usp_pGasInvD_NomEOM | This routine is used in the ‘Availability’ area of the EMS system and is used to |
| | | take a given volume amount and propagate that volume amount to all days in |
| | | the month. |
| 29.0 | Usp_LogAuditInfo | This routine is used to post record to the audit table within the system. |
| 30.0 | Usp_pPackageRevision | This routine is used to increment the revision number field on the deal. Certain |
| | | types of changes to a deal will automatically increment the revision number on a |
| | | deal and this update is done through this routine. |
| 31.0 | Usp_pPostClassificationRules | This procedure is executed (usually by triggers on the rDealClass and |
| | | rDealClassA tables). It can be executed stand-alone. This procedure will |
| | | ensure that a record is created in the rDealClassRules table for every |
| | | combination of deal classification codes (dcA values on the rDealClassA table). |
| 32.0 | Usp_ProdPush | This routine is used in the ‘Availability’ phase of EMS and is used to initially |
| | | populate a particular month with ownership interest information, by meter/well. |
| 33.0 | Usp_pPushMeter | This routine is used in the ‘Availability’ phase of EMS and is used to populate a |
| | | single meter/well ownership interest to its respective deal (package) and volume |
| | | inventory item (GasInv/GasInvD). |
| 34.0 | Usp_pRouteBuildLegHistory | This routine creates the ‘Leg’ records for a given meter/well. When a new ‘route’ |
| | | (Leg Ref) is defined on the system then this routine will get invoked to initially |
| | | seed the ‘Leg’ table with entries in order to allow routing. |
| 35.0 | Usp_pRouteBuildLegHistoryAll | This routine gets invoked when a production month is initially opened to the |
| | | ‘Sales’ phase. All ACTIVE meters and legs will have their respective ‘Leg’ table |
| | | records populated for that production month by this routine. |
| 36.0 | Usp_pRouteCopyLegHistoryActuals | This routine gets invoked when the status of a production month changes from |
| | | ‘Sales’ to ‘Invoiced’. All nomination routine instructions (in the ‘LegDetail’ table) |
| | | are then copied by this routine. This provides the mechanism to have actuals |
| | | different than noms while preserving the nom instructions. |
| 37.0 | Usp_pRoutePostChange | This procedure gets invoked whenever a change to a specific route is requested |
| | | (i.e. modifications of volumes between hops). |
| 38.0 | Usp_pRoutePostDealInfo | This procedure gets invoked to ‘seed’ the ‘LegDetail’ table with routing |
| | | information. This is invoked when new meters/wells are added to deals. |
| 39.0 | Usp_pRoutePostDealInfoVols | This procedure gets invoked to populate the specific volumes on each of the |
| | | ‘LegDetail’ entries (daily) for deal inventory items. |
| 40.0 | Usp_pRoutePostDelete | This procedure gets invoked whenever a deletion is requested on the routing |
| | | (LegDetail) information. |
| 41.0 | Usp_pRoutePostLegRates | This procedure gets invoked in order to post the rates (fuel, pvr, transport, |
| | | gathering, etc) to each of the ‘LegDetail’ records in the database. Daily rates |
| | | (LegD table) overrides monthly rates (Leg table) and this procedure ensures that |
| | | priority. If a rate gets changed for a leg this routine gets invoked to update all |
| | | existing routes (LegDetail) records. |
| 42.0 | Usp_pRoutePostSale | This procedure gets invoked in order to post volume (route it) to a sales item (in |
| | | the LegDetail table). |
| 43.0 | Usp_pRoutePostTransport | This procedure gets invoked in order to post volume (route it) to a transportation |
| | | point (in the LegDetail table). |
| 44.0 | Usp_pRouteRemoveLegDetails | This routine will remove any/all ‘LegDetail’ (routing instructions) when a |
| | | meter/well for a specific deal is removed. |
| 45.0 | Usp_pSERPT_GetAdditionalReportInfo | This routine is used by all of the ‘standard’ reporting procedures to obtain |
| | | specific report fields needed when running a standard report |
| 46.0 | Usp_pSERPT_PostReportToCorrespondence | This routine will post a ‘PackageCorrespondence’ table record to a particular |
| | | deal that is affected by the ‘standard’ report being run. This routine is called by |
| | | all standard report routines. |
| 47.0 | Usp_pSERPT_PostReportToDistribution | This routine will post a report distribution request to the SERptsQueueDistribute |
| | | table. This is either a request to ‘PRINTER’, ‘EMAlL’ or ‘FAX’. |
| 48.0 | Usp_pSERPT_PostReportToQueue | This routine is used by all of the standard report routines and will post an actual |
| | | report request (queue item) to the SERptsQueue table. |
| 49.0 | Usp_pSERPT_RunReportAvailConfirms | This routine is responsible for running the ‘Availability’ confirm reports. |
| 50.0 | Usp_pSERPT_RunReportAvailEstimates | This routine is responsible for running the ‘Availability’ estimate reports. |
| 51.0 | Usp_pSERPT_RunReportDealConfirm | This routine is responsible for running the deal confirmation reports (from the |
| | | deal detail screen on EMS). |
| 52.0 | Usp_pSERPT_RunReportInvoice | This routine is responsible for running all standard invoice reports. |
| 53.0 | Usp_pSERPT_RunReportRemittance | This routine is responsible for running all standard remittance reports. |
| 54.0 | Usp_pSERPT_RunReportVoucher | This routine is responsible for running all standard voucher reports. |
| 55.0 | Usp_pSERPT_SetAParameterBoolean | This routine is used by the standard reporting routines and converts Boolean |
| | | parameters for posting on the report queue (SERptsQueue) table. |
| 56.0 | Usp_pSERPT_SetAParameterDate | This routine is used by the standard reporting routines and converts date and |
| | | date/time parameters for posting on the report queue (SERptsQueue) table. |
| 57.0 | Usp_pSERPT_SetAParameterDecimal | This routine is used by the standard reporting routines and converts decimal |
| | | (number) parameters for posting on the report queue (SERptsQueue) table. |
| 58.0 | Usp_pSERPT_SetAParameterInteger | This routine is used by the standard reporting routines and converts integer |
| | | number parameters for posting on the report queue (SERptsQueue) table. |
| 59.0 | Usp_pSERPT_SetAParameterString | This routine is used by the standard reporting routines and converts string |
| | | parameters for posting on the report queue (SERptsQueue) table. |
| 60.0 | Usp_pSERPT_WhichReport | This routine is used by the standard reporting routines and is responsible for |
| | | determining WHICH report to use. The default reports are in KreportDefaults |
| | | table. However, any given contract can override the default (KreportOverrides |
| | | table). |
| 61.0 | Usp_PSPrice | This is the main pricing routine for the volume inventory items (regular |
| | | purchases and sales). |
| 62.0 | Usp_PSPriceAll | This is the main procedure for calculating the prices for a given month on a set |
| | | of deals (volume inventory pricing, STID 8 & 9). Parameters to this stored |
| | | procedure dictate the type of price to calculation (Nom of Pipe/Field Actual and |
| | | Sales versus Purchase. etc.). |
| 63.0 | Usp_PSPriceAnyNewInvoicesNeeded | This routine is responsible for assigning new invoice and remittance numbers to |
| | | the volume inventory table (GasInv). If new meters/wells (volume entries) get |
| | | entered during the actualization process then this routine will ensure they are |
| | | assigned unique numbers. |
| 64.0 | Usp_PSPriceAssignInvoiceNo | This routine assigns invoice numbers to all sales deals when the production |
| | | month is promoted to the ‘Invoiced’ phase. |
| 65.0 | Usp_PSPriceAuto | This procedure run everyday and checks for any production month either in the |
| | | ‘Sales’ or the ‘Invoiced’ phase. If any production months are within these |
| | | phases then this procedure will invoke the calculation routine |
| | | (usp_psAutoMonth) for them. |
| 66.0 | Usp_PSPriceAutoMonth | This is the main driver routine for the calculation of an entire month. |
| 67.0 | Usp_PSPriceComponentsCheck | This procedure will automatically insert system generated price components (like |
| | | WASP or Netback Percentage) to the Engine_Master table. It is invoked by the |
| | | usp_PSPriceI procedure when calculating prices on a deal for a given month. |
| 68.0 | Usp_PSPriceCost | This is the routine that calculates the ‘Other Cost’ entries and posts calculated |
| | | results in the Engine table. |
| 69.0 | Usp_PSPriceCostAll | This is the main driver routine for looping through all of the ‘Other Costs’ in a |
| | | given month and invoking the usp_PSPriceCost routine for each one. |
| 70.0 | Usp_PSPriceCreateActualEntries | This procedure copies the pricing entries setup on each deal |
| | | (Engine_MasterPrice) from nom to actuals. |
| 71.0 | Usp_PSPriceMarkActualAdjustments | This procedure gets invoked by the calculation routine to mark any volume |
| | | inventory item (GasInv) whenever a difference is detected between nominations |
| | | and actuals. |
| 72.0 | Usp_PSPricePopulateEngine | This procedure will populate the Engine table FROM the Engine_Master table. |
| | | For daily index price entries this procedure will automatically propagate the daily |
| | | index price to all days of the month where there is a volume (at least until a new |
| | | pricing entry is found). Only volume entries are populated here (STID 8 & 9). |
| 73.0 | Usp_PSPriceTransportAll | This routine calculates all of the transport costs for a given production month. |
| | | These transport costs (and volumes) are posted in the GasInv (pricetype=3) |
| | | table and deals are posted (if needed). These deals are tagged with the specific |
| | | transport contract. |
| 74.0 | Usp_PSPriceWASPCalc | Determines and resolves all wasp ‘Common’ and ‘Dedicated’ pools. Dedicated |
| | | pools are sanctioned sales. This is the main driver procedure for the wasp |
| | | portion of the calculation. Third party (pool = ‘None’) are also processed within |
| | | this procedure but not for the intent of obtaining a price for them, totals used |
| | | primarily for profit margin reporting |
| 75.0 | Usp_PSPriceWASPCalcResolveDriver | This is the main driver component for driving the WASP calculation. |
| 76.0 | Usp_PSPriceWASPCalcResolveN | Traces back sales totals from all sales meters back to their originating purchase |
| | | points. The table updated here is the WASPResolvedRouting table. The |
| | | ‘LegDetail’ table is used extensively in this calculation. This is a highly |
| | | ITERATIVE process |
| 77.0 | Usp_PSPriceWASPCalcResolveSalesN | This procedure creates the entries in the WASPResolvedRouting table and |
| | | posts original sales volumes and amounts. This is done just prior to the routine |
| | | that resolves these sales totals back to the purchase points. |
| 78.0 | Usp_PSPriceWASPCalcSalesN | Sums all WASPable sales by sales meter into the WASPSalesMeterTotals table. |
| 79.0 | Usp_PSPriceWASPClearMonth | This routine runs when a production month is promoted to ‘Completed’ phase. |
| | | Any volume inventory (GasInv andlor GasInvD) or routing items |
| | | (LegDetail) that contain zeros are removed so that only relevant information is |
| | | stored in the database for historical purposes. |
| 80.0 | Usp_PSPriceWaspDivieOutProceedsN | This procedure is the main procedure that will distribute the proceeds from those |
| | | deals that have been designated to have their respective proceeds distributed |
| | | via the ‘Financial Overrides’ setup on the deal. |
| 81.0 | Usp_ProdVolSet | This routine is used in the ‘Availability’ phase to setup the ownership interest on |
| | | a particular pipe/field and meter. ProdSum and ProdVol tables for the current |
| | | production month are populated with this procedure. |
| 82.0 | Usp_ProdVolSetAll | This routine is used in the ‘Availability’ phase to setup the ownership interest on |
| | | all pipe/fields and meters. This routine invokes the usp_ProdVolSet routine for |
| | | each meter/well in the loop. |
| 83.0 | Usp_PSRollover | This routine gets invoked when a production month goes from ‘Availability’ to |
| | | ‘Sales’ and is responsible for copying deal information month-to-month. |
| 84.0 | Usp_PSRolloverPopActuals3 | This routine gets invoked by the usp_PSRollover routine and is responsible for |
| | | populating noms with previous 3 months actuals numbers (primarily used for |
| | | Oil). |
| 85.0 | Usp_PSRolloverPopNoms | This routine gets invoked by the usp_PSRollover routine and is responsible for |
| | | populating noms with previous months nom numbers. |
| 86.0 | Usp_pStatusChanged | This routine gets invoked anytime the production month status is changed |
| | | (Initial,Availability,Sales,Invoiced,Accounting,Completed). Other routines are |
| | | invoked depending on the from and to status for the production month. |
| 87.0 | Usp_w.″ | Any stored procedure that begins with Usp_w_has been setup as a one time |
| | | only procedure that is used to correct any database items/etc. These |
| | | procedures can be permanently deleted and have no impact on existing |
| | | functions within EMS. |

Application Software

Technical Skill Set Required

Support and maintenance of the Energy Management System requires the following technical skill set.

| Ref # | Skill Set | Used For . . . |
|---|---|---|
| 1.0 | SQL-Server (Transact SQL) | All data is stored in MS SQL-Server database tables. This data is accessed via direct SQL |
| | | statements (embedded in windows applications, stored procedures and reports). There are |
| | | several database views that have been setup to access aggregated information (for performance |
| | | and consistency). In addition all of the critical calculations and time consuming procedures (like |
| | | the main EMS calculation, routing and rollover process) are written as Transact-SQL stored |
| | | procedures (and documented in this manual). |
| 2.0 | Delphi (V5+) | All client applications are written using this particular RAD tool. In addition to knowing the |
| | (includes Delphi 3^{rd} party tools) | standard components that come with this tool, any of the 3^{rd} party tools (documented in this |
| | | manual) are used extensively. See the 3^{rd} party tools listed in the ‘Tools Utilized’ section far more |
| | | details. |
| 3.0 | Crystal Reports (V8.0) | All reporting within EMS is done utilizing this tool from Seagate software. |

Client, Server Applications W/Tools Utilized

This particular section contains the high level documentation relative to the Energy Management System software application. Each item documented is uniquely numbered to aid in reviews and/or future modifications.

| Ref # | Item | Response | Comments |
|---|---|---|---|
| 1.0 | Client Application | Energy Management | The Energy Management System is written in Delphi 5 |
| | | System | (service pack 3 applied). Third party controls and |
| | | | components were used in the development. See other |
| | | | areas of this matrix for 3^{rd} party tools utilized. |
| 2.0 | Client Application | Producer Control | The Producer Control Center is written in Delphi 5 (service |
| | | Center | pack 3 applied). Third party controls and components were |
| | | | used in the development. See other areas of this matrix for |
| | | | 3^{rd} party tools utilized. This application provides a restricted |
| | | | view of information specific to the company/contact that is |
| | | | running the application. The data viewed is the same data |
| | | | that is maintained in the EMS system. |
| 3.0 | Server Application | Software Experts, Inc. | All reporting done within EMS utilizes Crystal reports. This |
| | | SECrystal (V8.00) | server application runs and stores all output reports for the |
| | | | System. Besides storing an electronic copy of the report. |
| | | | this server can distribute to a printer, fax folder OR an email |
| | | | address if instructed by the EMS application. |
| 4.0 | Server Application | Software Experts, Inc. | Some output reports (from SECrystal) are designated to be |
| | | SEFax (V2.00) | faxed. This software is responsible for faxing all of the |
| | | (outbound faxing) | reports that were designated by EMS to be faxed. |
| 5.0 | Server Application | Software Experts, Inc. | All database requests for the Energy Management System |
| | | SEServer (V2.00 g) | AND the Producer Control Center go through this database |
| | | (database request server) | server component. This server application typically runs on |
| | | | the same machine as the actual database. |
| 6.0 | 3^{rd} Party Tool/Library | Adobe | This free tool is used to view reports from EMS. The default |
| | | Acrobat Reader (V4.0+) | for all reports is to print them to a PDF format. This output |
| | | | format is ‘overrideable’ by the user when the report is |
| | | | submitted. Other formats like Excel, Word, Text, etc. are |
| | | | also supported. |
| 7.0 | 3^{rd} Party Tool/Library | Seagate Software | All reports are written using the Crystal reporting tool from |
| | | Crystal Reports (V8.00) | Seagate Software). In addition, the report server |
| | | | (SECrystal) utilizes the main Crystal reporting FREE runtime |
| | | | libranes to run these reports for all EMS client requests. |
| 8.0 | 3^{rd} Party Tool/Library | Dalco Technologies | Delphi VCL components that provide internet (TCP/IP) |
| | | DbOvernet (V2.00) | access. The SEServer application utilizes this middleware. |
| 9.0 | 3^{rd} Party Tool/Library | TurboPower Software | The SEFax fax server application utilizes this 3^{rd} party |
| | | Asynch Pro (V3.04) | Delphi VCL component list for sending and/receiving faxes. |
| | | | The SECrystal reporting server application uses this library |
| | | | to write out ‘fax ready’ files. |
| 10.0 | 3^{rd} Party Tool/Library | TurboPower Software | Many of the online screens for all client and server |
| | | Orpheus (V3.08) | applications utilize the Orpheus controls for screen grid lists, |
| | | | combo boxes, etc. The server applications were written with |
| | | | this tool set also. |
| 11.0 | 3^{rd} Party Tool/Library | TurboPower Software | Many of the online screens for all client and server |
| | | SysTools (V3.02) | applications utilize the SysTools components for string |
| | | | manipulations, spawning tasks, etc. |
| 12.0 | 3^{rd} Party Tool/Library | Woll2Woll Software | Many of the online screens for all client and server |
| | | InfoPower 2000.17 | applications utilize these controls for screen grid lists. |
| | | | combo boxes, etc. The server applications were written with |
| | | | this tool set also. |
| 13.0 | 3^{rd} Party Tool/Library | Inner Media.Software | These are Delphi software components that are for |
| | | Dynazip (V4.00) | compression/decompression of files to and from the server. |
| | | | This is used by both the client and server applications. |
| 14.0 | 3^{rd} Party Tool/Library | Public Domain | This is a Delphi software component and is used by the |
| | | TEmail (V2.10) | client and server applications. It is responsible for the email |
| | | | interface. |
| 15.0 | 3^{rd} Party Tool/Library | TMS Software | This is a Delphi software component that provides for ‘over |
| | | TwebUpdate (V1.00) | the internet’ automatic software upgrades. The client |
| | | | applications each utilize this component. |
| 16.0 | 3^{rd} Party Tool/Library | Skyline Software, Inc. | These are Delphi software components that provide for |
| | | ImageLib Suite (V5.00) | graphic images displayed within the application. In addition, |
| | | | this software provides scanner input capabilities. |

Client Applications, Module List/Descriptions

This particular section Contains the high level documentation relative to each software application module within the Energy Management System. Each item documented is uniquely numbered to aid in reviews and/or future modifications. The application reference listed below will either indicate EMS (Energy Management System) and/or PCC (Producer Control Center). This shows the level of interoperability between these two client applications. All of these modules are written in Delphi (Object Pascal, (Visual)).

| Ref # | Module Name | Module Type | Application | Description/Comments |
|---|---|---|---|---|
| 1.0 | DBAddress | Data Module | EMS | This module contains all ot the database communication |
| | | | PCC | components for the Address (‘Company and Contact |
| | | | | Addresses’) table. |
| 2.0 | DBCommonDatabase | Data Module | EMS | This module is responsible for setting all of the common |
| | | | PCC | properties for all other data modules within the system. |
| | | | | Prior to invoking a query, all other database modules will |
| | | | | invoke methods within this module to set communication |
| | | | | ports, maximum number of records, etc. This module also |
| | | | | stores the actual user id and contains methods for |
| | | | | accessing this field. |
| 3.0 | DBCommonFileOperations | Data Module | EMS | This module handles all of the ‘flat file’ operations |
| | | | PCC | (compressing/decompressing/etc.) that is involved with the |
| | | | | applications. Any temporary files that need to be created |
| | | | | are also controlled by this data module. |
| 4.0 | DBCompany | Data Module | EMS | This module contains all of the database communication |
| | | | PCC | components for the Company (‘Company Information’) |
| | | | | table. |
| 5.0 | DBContactFunction | Data Module | EMS | This module contains all of the database communication |
| | | | PCC | components for the ContactFunction (“Roles within their |
| | | | | respective companies that contacts play”) table. |
| 6.0 | DBContacts | Data Module | EMS | This module contains all of the database communication |
| | | | PCC | components for the Contacts (‘Individual contacts within |
| | | | | companies’) table. |
| 7.0 | DBContactGroup | Data Module | EMS | This module contains all of the database communication |
| | | | PCC | components for the ContactGroup (Links contacts to |
| | | | | groups they may be affiliated with) table. |
| 8.0 | DBContact_GroupNames | Data Module | EMS | This module contains all of the database communication |
| | | | | components for the Contact_GroupNames (table contains |
| | | | | a record for each group within the system) table. |
| 9.0 | DBEngine | Data Module | EMS | This module contains all of the database communication |
| | | | | components for the Engine (contains transaction records |
| | | | | for each volume inventory transaction item associated with |
| | | | | the deal) table. |
| 10.0 | DBEngine_Master | Data Module | EMS | This module contains all of the database communication |
| | | | | components for the Engine_Master (User enterable pricing |
| | | | | area ‘header’ record) table. |
| 11.0 | DBEngine_MasterPrice | Data Module | EMS | This module contains all of the database communication |
| | | | | components for the Engine_MasterPrice (User enterable |
| | | | | pricing area ‘detail’ records (price tags)) table. |
| 12.0 | DBEngine_TransactionList | Data Module | EMS | This module contains all of the database communication |
| | | | | components for the Engine_TransactionList (transaction |
| | | | | descriptions) table. |
| 13.0 | DBExceptionCategories | Data Module | EMS | This module contains all of the database communication |
| | | | PCC | components for the ExceptionCategories (‘Reasons for |
| | | | | Exceptions’) table. |
| 14.0 | DBExceptionList | Data Module | EMS | This module contains all of the database communication |
| | | | PCC | components for the ExceptionList (‘Actual Exception |
| | | | | Events) table. |
| 15.0 | DBGasInv | Data Module | EMS | This module contains all of the database communication |
| | | | | components for the GasInv (Volume Inventory ‘header’) |
| | | | | table. |
| 16.0 | DBGasInvD | Data Module | EMS | This module contains all of the database communication |
| | | | | components for the GasInvD (Volume Inventory Daily |
| | | | | ‘detail’) table. |
| 17.0 | DBGCButton | Data Module | EMS | This module contains all of the database communication |
| | | | PCC | components for the GCButton (‘Business Functions’) |
| | | | | security table. |
| 18.0 | DBGCIndex | Data Module | EMS | This module contains all of the database communication |
| | | | PCC | components for the GCIndex (Daily & Monthly Price |
| | | | | Indices) table. |
| 19.0 | DBGCSecurity | Data Module | EMS | This module contains all of the database communication |
| | | | PCC | components for the GCSecurity (Security Authorizations) |
| | | | | for the applications. |
| 20.0 | DBGCUser | Data Module | EMS | This module contains all of the database communication |
| | | | PCC | components for the GCUser (User Profiles) table within the |
| | | | | applications. |
| 21.0 | DBImages | Data Module | EMS | This module contains all of the database communication |
| | | | | components for the SEImages (company logos, etc.) table |
| | | | | within the application. |
| 21.0 | DBIndexBasketLink | Data Module | EMS | This module contains all of the database communication |
| | | | PCC | components for the IndexBasketLink (Links actual indices |
| | | | | to a particular basket) table within the application. |
| 22.0 | DBIndexBaskets | Data Module | EMS | This module contains all of the database communication |
| | | | PCC | components for the IndexBaskets (Grouping of indices to |
| | | | | be used in a ‘simple’ averaging calculation) table within the |
| | | | | application. |
| 23.0 | DBIndexRef | Data Module | EMS | This module contains all of the database-communication |
| | | | PCC | components for the IndexRef (Each price index within the |
| | | | | system contains a record entry here) table within the |
| | | | | application. |
| 24.0 | DBK | Data Module | EMS | This module contains all of the database communication |
| | | | | components for the K (Contracts table within the |
| | | | | application). |
| 25.0 | DBKNetBack | Data Module | EMS | This module contains all of the database communication |
| | | | | components for the KNetBack (Contracts Netback |
| | | | | Percentage Tiers) table within the application. |
| 26.0 | DBKNotes | Data Module | EMS | This module contains all of the database communication |
| | | | | components for the KNotes (Contract Notes) table within |
| | | | | the application. |
| 27.0 | DBKProducts | Data Module | EMS | This module contains all of the database communication |
| | | | | components for the KProducts (products that are available |
| | | | | within contracts) table within the application. |
| 28.0 | DBKReportDefaults | Data Module | EMS | This module contains all of the database communication |
| | | | | components for the KReportDefaults (standard report |
| | | | | defaults) table within the application. |
| 29.0 | DBKReportOverrides | Data Module | EMS | This module contains all of the database communication |
| | | | | components for the KReportOverrides (standard report) |
| | | | | overrides for a contract) table within the application. |
| 30.0 | DBKServices | Data Module | EMS | This module contains all of the database communication |
| | | | | components for the KServices (services that are available |
| | | | | within contracts) table within the application. |
| 31.0 | DBLeg | Data Module | EMS | This module contains all of the database communication |
| | | | | components for the Leg (available routes and rates for the |
| | | | | production month) table within the application. |
| 32.0 | DBLegD | Data Module | EMS | This module contains all of the database communication |
| | | | | components for the LegD (available DAILY routes and |
| | | | | rates for the production) table within the application. |
| 33.0 | DBLegDetail | Data Module | EMS | This module contains all of the database communication |
| | | | | components for the LegDetail (specific routing instructions |
| | | | | for all volumes purchased and sold) table within the |
| | | | | application. |
| 34.0 | DBLegRef | Data Module | EMS | This module contains all of the database communication |
| | | | | components for the LegRef (master list of routes and rates) |
| | | | | table within the application. |
| 35.0 | DBLocations | Data Module | EMS | This module contains all of the database communication |
| | | | PCC | components for SELocations (locations) table within the |
| | | | | application. |
| 36.0 | DBMessages | Data Module | EMS | This module contains all of the database communication |
| | | | PCC | components for the SEMessages (system messages) table |
| | | | | within the application. |
| 37.0 | DBMeter | Data Module | EMS | This module contains all of the database communication |
| | | | | components for the Meter/Well table within the application. |
| 38.0 | DBMeterAllocations | Data Module | EMS | This module contains all of the database communication |
| | | | | components for the MeterAllocations (ownership interests |
| | | | | in volume from a meter/well) table within the application. |
| 39.0 | DBMeterNotes | Data Module | EMS | This module contains all of the database communication |
| | | | | components for the MeterNotes table within the |
| | | | | application. |
| 40.0 | DBMeterRates | Data Module | EMS | This module contains all of the database communication |
| | | | | components for the MeterRates (pressure base, Btu factor, |
| | | | | etc. from a meter/well) table within the application. |
| 41.0 | DBMiscQueries | Data Module | EMS | This module contains all of the miscellaneous queries that |
| | | | PCC | were created to enable views of various tables within the |
| | | | | application. |
| 42.0 | DBPackage | Data Module | EMS | This module contains all of the database communication |
| | | | | components for the Package (Deals) table within the |
| | | | | application. |
| 43.0 | DBPackageCorrespondence | Data Module | EMS | This module contains all of the database communication |
| | | | | components for the PackageCorrespondence (electronic |
| | | | | copies of documents associated with deals) table within |
| | | | | the application. |
| 44.0 | DBPackageCosts | Data Module | EMS | This module contains all of the database-communication |
| | | | | components for the PackageCosts (‘Other Costs’ |
| | | | | associated with deals) table within the application. |
| 45.0 | DBPipeField | Data Module | EMS | This module contains all of the database communication |
| | | | | components for the PipeField (Pipe/Field information) table |
| | | | | within the application. |
| 46.0 | DBPriceComponents | Data Module | EMS | This module contains all of the database communication |
| | | | | components for the PriceComponents (tags to associate to |
| | | | | each portion of a price) table within the application. |
| 47.0 | DBPriceDesc | Data Module | EMS | This module contains all of the database communication |
| | | | | components for the PriceDesc (Deal free form price |
| | | | | description) table within the application. |
| 48.0 | DBPrinterDef | Data Module | EMS | This module contains all of the database communication |
| | | | | components for the PrinterDef (printer definitions) table |
| | | | | within the application. |
| 49.0 | DBProcessingCodes | Data Module | EMS | This module contains all of the database communication |
| | | | PCC | components for the SEProcessingCodes (reference code |
| | | | | description) table within the application. |
| 50.0 | DBProcessingCodeTyes | Data Module | EMS | This module contains all of the database communication |
| | | | | components for the SEProcessingCodeTypes (type codes |
| | | | | that classify sets of reference codes) table within the |
| | | | | application. |
| 51.0 | DBProducerMessage | Data Module | PCC | This module contains all of the database communication |
| | | | | components for the ProducerMessage (dynamic messages |
| | | | | posted to producers) table within the application. |
| 52.0 | DBProdInterest | Data Module | EMS | This module contains all of the database communication |
| | | | | components for the ProdInterest (Availability royalty |
| | | | | interests) table within the application. |
| 53.0 | DBProdPKG | Data Module | EMS | This module contains all of the database communication |
| | | | | components for the ProdPKG (Availability deal ID to |
| | | | | ProdVol cross reference) table within the application. |
| 54.0 | DBProdSum | Data Module | EMS | This module contains all of the database communication |
| | | | | components for the ProdSum (Availability summary totals |
| | | | | by meter/well) table within the application. |
| 55.0 | DBProdVol | Data Module | EMS | This module contains all of the database communication |
| | | | | components for the ProdVol (Availability detail owner |
| | | | | interest totals by meter/well) table within the application. |
| 56.0 | DBrDealClass | Data Module | EMS | This module contains all of the database communication |
| | | | | components for the rDealClass (All of the available deal |
| | | | | classifications) table within the application. |
| 57.0 | DBrDealClassA | Data Module | EMS | This module contains all of the database communication |
| | | | | components for the rDealClassA (all possible answers |
| | | | | available to the deal class rules (rDealClass table)) table |
| | | | | within the application. |
| 58.0 | DBrDealClassRules | Data Module | EMS | This module contains all of the database communication |
| | | | | components for the rDealClassRules (all rules associated |
| | | | | with every combination of deal classification) table within |
| | | | | the application. |
| 59.0 | DBrGasMonth | Data Module | EMS | This module contains all of the database communication |
| | | | PCC | components for the rGasMonth (an entry exists here for |
| | | | | every possible month within the system, with status |
| | | | | information) table within the application. |
| 60.0 | DBRptsControl | Data Module | EMS | This module represents the main driver module for |
| | | | PCC | submitting reports. |
| 61.0 | DBRptsExecutedStats | Data Module | EMS | This module contains all of the database communication |
| | | | PCC | components for the SERptsExecutedStats (Execution |
| | | | | statistics for reports) table within the application. |
| 62.0 | DBRptsGroupitems | Data Module | EMS | This module contains all of the database communication |
| | | | PCC | components for the SERptsGroupItems (List of reports |
| | | | | available within each tab/folder) table within the |
| | | | | application. |
| 63.0 | DBRptsGroups | Data Module | EMS | This module contains all of the database communication |
| | | | PCC | components for the SERptsGroups (List of all tabs within |
| | | | | each reporting folder) table within the application. |
| 64.0 | DBRptsItemDetail | Data Module | EMS | This module contains all of the database communication |
| | | | PCC | components for the SERptsItemDetail (List of specific |
| | | | | reports available throughout all folders and tabs) table |
| | | | | within the application. |
| 65.0 | DBRptsItemParms | Data Module | EMS | This module contains all of the database communication |
| | | | PCC | components for the SERptsItemParms (List of all report |
| | | | | parameters available to each specific report) table within |
| | | | | the application. |
| 66.0 | DBRptsQueue | Data Module | EMS | This module contains all of the database communication |
| | | | PCC | components for the SERptsQueue (actual report |
| | | | | submission queue) table within the application. |
| 67.0 | DBRptsQueueDistribute | Data Module | EMS | This module contains all of the database communication |
| | | | PCC | components for the SERptsOueueDistribute (report |
| | | | | distribution instructions area) table within the application. |
| 68.0 | DBRptsQueueNotify | Data Module | EMS | This module contains all of the database communication |
| | | | PCC | components for the SERptsQueueNotify (report notification |
| | | | | instructions area) table within the aoplication. |
| 69.0 | DBRptsSchedule | Data Module | EMS | This module contains all of the database communication |
| | | | PCC | components for the SERptsSchedule (report schedule |
| | | | | definition area) table within the application. |
| 70.0 | DBRptsScheduledReports | Data Module | EMS | This module contains all of the database communication |
| | | | PCC | components for the SERptsScheduledReports (reports |
| | | | | belonging to schedule definition area) table within the |
| | | | | application. |
| 71.0 | DBRptsScheduleGroups | Data Module | EMS | This module contains all of the database communication |
| | | | PCC | components for the SERptsScheduleGroups (report |
| | | | | schedule groups definition area) table within the |
| | | | | application. |
| 72.0 | DBRptsScheduleUserGroups | Data Module | EMS | This module contains all of the database communication |
| | | | PCC | components for the SERptsScheduleUserGroups (user list |
| | | | | belonging to a specific schedule group definition area) |
| | | | | table within the application. |
| 73.0 | DBRptsTablesUsed | Data Module | EMS | This module contains all of the database communication |
| | | | PCC | components for the SERptsTablesUsed (tables, views and |
| | | | | stored procedures used by each report area) table within |
| | | | | the application. |
| 74.0 | DBStoredProcedures | Data Module | EMS | This module contains all of the database communication |
| | | | PCC | components for accessing and invoking all stored |
| | | | | procedures and functions on the application. Each of |
| | | | | these procedures are setup as methods within this class |
| | | | | and this particular class acts as a common wrapper for |
| | | | | invoking these DB procedures. |
| 75.0 | RTCrystalDriverParseMemo | Business Rules | EMS | This module contains all of the string parsing routines used |
| | | | PCC | to store reporting parameters, formulas and selection |
| | | | | criteria. |
| 76.0 | RTDBAddress | Business Rules | EMS | All business rules and edits associated with the application |
| | | | PCC | addresses (Address table) are within this particular |
| | | | | module. |
| 77.0 | RTDBCompany | Business Rules | EMS | All business rules and edits associated with the application |
| | | | PCC | companies (Company table) are within this particular |
| | | | | module. |
| 78.0 | RTDBContactFunction | Business Rules | EMS | All business rules and edits associated with the application |
| | | | PCC | contact function (ContactFunction table) are within this |
| | | | | particular module. |
| 79.0 | RTDBContacts | Business Rules | EMS | All business rules and edits associated with the application |
| | | | PCC | contacts (contacts table) are within this particular module. |
| 80.0 | RTDBContact_Group | Business Rules | EMS | All business rules and edits associated with the application |
| | | | PCC | contact group relationships (ContactGroup table) are within |
| | | | | this particular module. |
| 81.0 | RTDBContact_GroupNames | Business Rules | EMS | All business rules and edits associated with the application |
| | | | | contact group names (Contact_GroupNames table) are |
| | | | | within this particular module. |
| 82.0 | RTDBEngine | Business Rules | EMS | All business rules and edits associated with the application |
| | | | | engine pricing transaction (Engine table) are within this |
| | | | | particular module. |
| 83.0 | RTDBEngine_Master | Business Rules | EMS | All business rules and edits associated with the application |
| | | | | engine pricing entry (Engine_Master table) are within this |
| | | | | particular module. |
| 84.0 | RTDBEngine_MasterPrice | Business Rules | EMS | All business rules and edits associated with the application |
| | | | | engine pricing components (w/price tags) entry |
| | | | | (Engine_MasterPrice table) are within this particular |
| | | | | module. |
| 85.0 | RTDBEngine_TransactionList | Business Rules | EMS | All business rules and edits associated with the application |
| | | | | engine transaction master list (Engine_TansactionList |
| | | | | table) are within this particular module. |
| 86.0 | RTDBExceptionCategories | Business Rules | EMS | All business rules and edits associated with the application |
| | | | PCC | exception categories (ExceptionCategories table) are |
| | | | | within this particular module. |
| 87.0 | RTDBExceptionList | Business Rules | EMS | All business rules and edits associated with the application |
| | | | PCC | exception list (ExceptionList table) are within this particular |
| | | | | module. |
| 88.0 | RTDBGasinv | Business Rules | EMS | All business rules and edits associated with the application |
| | | | | volume inventory transaction header (Gasinv table) are |
| | | | | within this particular module. |
| 89.0 | RTDBGasinvD | Business Rules | EMS | All business rules and edits associated with the application |
| | | | | volume inventory transaction detail daily (GasinvD table) |
| | | | | are within this particular module. |
| 90.0 | RTDBGCButton | Business Rules | EMS | All business rules and edits associated with the application |
| | | | PCC | business functions (GCButton table) are within this |
| | | | | particular module. |
| 91.0 | RTDBGCIndex | Business Rules | EMS | All business rules and edits associated with the application |
| | | | PCC | price indices (GCIndex table) are within this particular |
| | | | | module. |
| 92.0 | RTDBGCSecurity | Business Rules | EMS | All business rules and edits associated with the application |
| | | | PCC | security authorizations (GCSecurity table) are within this |
| | | | | particular module. |
| 93.0 | RTDBGCUser | Business Rules | EMS | All business rules and edits associated with the application |
| | | | PCC | users (GCUser table) are within this particular module. |
| 94.0 | RTDBImages | Business Rules | EMS | All business rules and edits associated with the application |
| | | | | graphic images (SEImages table) are within this particular |
| | | | | module. |
| 95.0 | RTDBIndexBasketLink | Business Rules | EMS | All business rules and edits associated with the application |
| | | | PCC | index price basket link (IndexBasketLink table) are within |
| | | | | this particular module. |
| 96.0 | RTDBIndexBaskets | Business Rules | EMS | All business rules and edits associated with the application |
| | | | PCC | index price baskets (IndexBaskets table) are within this |
| | | | | particular module. |
| 97.0 | RTDBIndexRef | Business Rules | EMS | All business rules and edits associated with the application |
| | | | PCC | price index master list (IndexRef table) are within this |
| | | | | particular module. |
| 98.0 | RTDBK | Business Rules | EMS | All business rules and edits associated with the application |
| | | | | contracts (K table) are within this particular module. |
| 99.0 | RTDBKNetBack | Business Rules | EMS | All business rules and edits associated with the application |
| | | | | contract netback pricing tiers (KNetBack table) are within |
| | | | | this particular module. |
| 100.0 | RTDBKNotes | Business Rules | EMS | All business rules and edits associated with the application |
| | | | | contract free form note area (KNotes table) are within this |
| | | | | particular module. |
| 101.0 | RTDBKProducts | Business Rules | EMS | All business rules and edits associated with the application |
| | | | | contract products area (KProducts table) are within this |
| | | | | particular module. |
| 102.0 | RTDBKReportDefaults | Business Rules | EMS | All business rules and edits associated with the application |
| | | | | contract standard report defaults area (KReportDefaults |
| | | | | table) are within this particular module. |
| 103.0 | RTDBKReportOverrides | Business Rules | EMS | All business rules and edits associated with the application |
| | | | | contract standard report overrides area (KReportOverrides |
| | | | | table) are within this particular module. |
| 104.0 | RTDBKServices | Business Rules | EMS | All business rules and edits associated with the application |
| | | | | contract services area (KServices table) are within this |
| | | | | particular module. |
| 105.0 | RTDBLeg | Business Rules | EMS | All business rules and edits associated with the application |
| | | | | leg (monthly) area (Leg table) are within this particular |
| | | | | module. |
| 106.0 | RTDBLegD | Business Rules | EMS | All business rules and edits associated with the application |
| | | | | leg (daily) area (LegD table) are within this particular |
| | | | | module. |
| 107.0 | RTDBLegDetail | Business Rules | EMS | All business rules and edits associated with the application |
| | | | | leg detail (main routing) area (LegDetail table) are within |
| | | | | this particular module. |
| 108.0 | RTDBLegRef | Business Rules | EMS | All business rules and edits associated with the application |
| | | | | leg master list area (LegRef table) are within this particular |
| | | | | module. |
| 109.0 | RTDBLocations | Business Rules | EMS | All business rules and edits associated with the application |
| | | | PCC | locations (SELocations table) are within this particular |
| | | | | module. |
| 110.0 | RTDBMessages | Business Rules | EMS | All business rules and edits associated with the application |
| | | | PCC | messages (SEMessages table) are within this particular |
| | | | | module. |
| 111.0 | RTDBMeter | Business Rules | EMS | All business rules and edits associated with the application |
| | | | | meters (Meter table) are within this particular module. |
| 112.0 | RTDBMeterAllocations | Business Rules | EMS | All business rules and edits associated with the application |
| | | | | meter ownership allocations (MeterAllocations table) are |
| | | | | within this particular module. |
| 113.0 | RTDBMeterNotes | Business Rules | EMS | All business rules and edits associated with the application |
| | | | | meter comment areas (MeterNotes table) are within this |
| | | | | particular module. |
| 114.0 | RTDBMeterRates | Business Rules | EMS | All business rules and edits associated with the application |
| | | | | meter rate areas (MeterRates table) are within this |
| | | | | particular module. |
| 115.0 | RTDBPackage | Business Rules | EMS | All business rules and edits associated with the application |
| | | | | deals (Package table) are within this particular module. |
| 116.0 | RTDBPackageCorrespondence | Business Rules | EMS | All business rules and edits associated with the application |
| | | | | deal correspondence (PackageCorrespondence table) are |
| | | | | within this particular module. |
| 117.0 | RTDBPackageCosts | Business Rules | EMS | All business rules and edits associated with the application |
| | | | | deal ‘Other Coats’ (PackageCosts table) are within this |
| | | | | particular module. |
| 118.0 | RTDBPipeField | Business Rules | EMS | All business rules and edits associated with the application |
| | | | | pipes/fields (PipeField table) are within this particular |
| | | | | module. |
| 119.0 | RTDBPriceComponents | Business Rules | EMS | All business rules and edits associated with the application |
| | | | | price components (PriceComponents table) are within this |
| | | | | particular module. |
| 120.0 | RTDBPriceDesc | Business Rules | EMS | All business rules and edits associated with the application |
| | | | | deal pricing free form text area (PriceDesc table) are within |
| | | | | this particular module. |
| 121.0 | RTDBPrinterDef | Business Rules | EMS | All business rules and edits associated with the application |
| | | | | printer definitions (PrinterDef table) are within this |
| | | | | particular module. |
| 122.0 | RTDBProcessingCodes | Business Rules | EMS | All business rules and edits associated with the application |
| | | | PCC | processing codes (SEProcessingCodes table) are within |
| | | | | this particular module. |
| 123.0 | RTDBProcessingCodeTypes | Business Rules | EMS | All business rules and edits associated with the application |
| | | | | processing code types (SEProcessingCodeTypes table) |
| | | | | are within this particular module. |
| 124.0 | RTDBProdInterest | Business Rules | EMS | All business rules and edits associated with the application |
| | | | | ‘Availability’ royalty interests (Prodinterest table) are within |
| | | | | this particular module. |
| 125.0 | RTDBProdPKG | Business Rules | EMS | All business rules and edits associated with the application |
| | | | | ‘Availability’ deal to ProdVol cross-reference (ProdPKG |
| | | | | table) are within this particular module. |
| 126.0 | RTDBProdSum | Business Rules | EMS | All business rules and edits associated with the application |
| | | | | ‘Availability’ monthly meter summary (ProdSum table) are |
| | | | | within this particular module. |
| 127.0 | RTDBProdVol | Business Rules | EMS | All business rules and edits associated with the application |
| | | | | ‘Availability’ monthly ownership volume (ProdVol table) are |
| | | | | within this particular module. |
| 128.0 | RTDBrDealClass | Business Rules | EMS | All business rules and edits associated with the application |
| | | | | deal classification options (rDealClass table) are within this |
| | | | | particular module. |
| 129.0 | RTDBrDealClassA | Business Rules | EMS | All business rules and edits associated with the application |
| | | | | deal classification answers (rDealClassA table) are within |
| | | | | this particular module. |
| 130.0 | RTDBrDealClassRules | Business Rules | EMS | All business rules and edits associated with the application |
| | | | | deal classification wasp rules (rDealClassRules table) are |
| | | | | within this particular module. |
| 131.0 | RTDBrGasMonth | Business Rules | EMS | All business rules and edits associated with the application |
| | | | PCC | production month (rGasMonth table) are within this |
| | | | | particular module. |
| 132.0 | RTDBRptsExecutedStats | Business Rules | EMS | All business rules and edits associated with the application |
| | | | PCC | execution statistics for reporting (SERptsExecutedSlats |
| | | | | table) are within this particular module. |
| 133.0 | RTDBRptsGroupItems | Business Rules | EMS | All business rules and edits associated with the application |
| | | | PCC | tab items for reporting (SERptsGroupItems table) are |
| | | | | within this particular module. |
| 134.0 | RTDBRptsGroups | Business Rules | EMS | All business rules and edits associated with the application |
| | | | PCC | tabs for reporting (SERptsGroups table) are within this |
| | | | | particular module. |
| 135.0 | RTDBRptsItemDetail | Business Rules | EMS | All business rules and edits associated with the application |
| | | | PCC | report files used for reporting (SERptsItemDetail table) are |
| | | | | within this particular module. |
| 136.0 | RTDBRptsItemParms | Business Rules | EMS | All business rules and edits associated with the application |
| | | | PCC | report file parameters used for reporting |
| | | | | (SERptsItemParms table) are within this particular module. |
| 138.0 | RTDBRptsQueue | Business Rules | EMS | All business rules and edits associated with the application |
| | | | PCC | report submission queue used for reporting (SERptsQueue |
| | | | | table) are within this iparticular module. |
| 139.0 | RTDBRptsQueueDistribute | Business Rules | EMS | All business rules and edits associated with the application |
| | | | PCC | report queue distribution options used for reporting |
| | | | | (SERptsQueueDistribute table) are within this particular |
| | | | | module. |
| 140.0 | RTDBRptsQueueNotify | Business Rules | EMS | All business rules and edits associated with the application |
| | | | PCC | report queue submission notifications used for reporting |
| | | | | (SERptsQueueNotify table) are within this particular |
| | | | | module. |
| 141.0 | RTDBRptsSchedule | Business Rules | EMS | All business rules and edits associated with the application |
| | | | PCC | report schedules used for reporting (SERptsSchedule |
| | | | | table) are within this particular module. |
| 142.0 | RTDBRptsScheduledReports | Business Rules | EMS | All business rules and edits associated with the application |
| | | | PCC | report schedule actual reports used for reporting |
| | | | | (SERptsScheduledReports table) are within this particular |
| | | | | module. |
| 143.0 | RTDBRptsScheduleGroups | Business Rules | EMS | All business rules and edits associated with the application |
| | | | PCC | report schedule groups used for reporting |
| | | | | (SERptsScheduleGroups table) are within this particular |
| | | | | module. |
| 144.0 | RTDBRptsScheduleUserGroups | Business Rules | EMS | All business rules and edits associated with the application |
| | | | PCC | report schedule users (in groups) used for reporting |
| | | | | (SERptsScheduleUserGroups table) are within this |
| | | | | particular module. |
| 145.0 | RTDBRptsTablesUsed | Business Rules | EMS | All business rules and edits associated with the application |
| | | | PCC | report tables used for reporting (SERptsTablesUsed table) |
| | | | | are within this particular module. |
| 146.0 | RTMessageStackClient | Business Rules | EMS | This particular module is responsible for maintaining the |
| | | | PCC | current list of messages that will be displayed to the user. |
| | | | | This module will provide for the storing of up to 50 |
| | | | | messages (in memory tables) in between enter button or |
| | | | | mouse clicks. This provides for any/all error messages |
| | | | | concerning a specific event to be displayed at once versus |
| | | | | one at a time. |
| 147.0 | FmAbout | Form | EMS | This form provides descriptive information about the |
| | | | PCC | application (version number, copyright notice, email and |
| | | | | website support links. etc). |
| 148.0 | FmActualizePurchases | Form | EMS | This form provides the method for performing (Step 2 of 4) |
| | | | | of the actualization process within EMS. |
| 149.0 | FmActualizeSales | Form | EMS | This form provides the method for performing (Step 3 of 4) |
| | | | | of the actualization process within EMS. |
| 150.0 | FmAddressDetail | Form | EMS | This form provides for the updating of addresses for |
| | | | | contacts and companies. The table that gets updated |
| | | | | behind the scenes is the Address table. |
| 151.0 | FmAddressList | Form | EMS | This form provides a list of all available addresses that |
| | | | | have already been setup for a company. Options on this |
| | | | | form include an ability to change, add or delete address |
| | | | | lines from the list. |
| 152.0 | FmBusinessFunctionsDetail | Form | EMS | This form provides for the updating of the business |
| | | | | functions that are available within the Energy Management |
| | | | | System AND the Producer Control Center. The table that |
| | | | | gets updated (behind the scenes) is the ‘GCButton’ table. |
| 153.0 | FmBusinessFunctionsList | Form | EMS | This form provides a list of all available business functions |
| | | | | that are currently within the Energy Management System |
| | | | | AND the Producer Control Center. Options exist here to |
| | | | | add, change and delete business functions. Each of these |
| | | | | business functions represent areas within the application |
| | | | | for setting system security. |
| 154.0 | FmCommon | Form | EMS | This form provides for all of the common properties used |
| | | | PCC | by all forms. This form can be accessed via the main |
| | | | | menus by selecting system properties. All of the color |
| | | | | schemes, graphic images, etc. that are used by the system |
| | | | | are included on this form. At runtime, all other forms within |
| | | | | the system will invoke public methods within this form to |
| | | | | set their respective screen fields. |
| 155.0 | FmCompanyDetail | Form | EMS | This form provides the mechanism for updating detail |
| | | | | information pertaining to a specific company. This includes |
| | | | | identification of a primary company address. |
| 156.0 | FmCompanyList | Form | EMS | This form provides a grid list of all companies that are |
| | | | | currently stored on EMS. Options on this form include |
| | | | | extensive lookup and tab options. |
| 157.0 | FmContactDetail | Form | EMS | This form provides the form for updating detail information |
| | | | | about a contact at a particular company. This includes |
| | | | | group memberships, functions, etc. |
| 158.0 | FmContactFunctionDetail | Form | EMS | This form provides the mechanism for associating a |
| | | | | contact within a company to a specific job function at the |
| | | | | company (i.e. Accounting, production, etc.) |
| 159.0 | FmContactGroupDetail | Form | EMS | This form provides the mechanism for creating or updating |
| | | | | contact groups on the system. |
| 160.0 | FmContactGroupList | Form | EMS | This form lists all available contact groups on the system. |
| | | | | Options on this form include an ability to add, change or |
| | | | | delete a contact group. |
| 161.0 | FmContactList | Form | EMS | This for lists all contacts within all companies. Options on |
| | | | | this form include an ability to add, change or delete a |
| | | | | specific contact (with appropriate security). In addition, |
| | | | | there are extensive data lookup capabilities. |
| 162.0 | fmContactSecurityAuth | Form | EMS | This form provides for the entry of external company |
| | | | | security authorization rules (i.e. Enabling access to |
| | | | | Producer Control Center. etc.). |
| 163.0 | FmContractDetail | Form | EMS | This form represents the detail form for entering contract |
| | | | | specific information (netback pricing information, contract |
| | | | | name, terms, provisions, etc.). |
| 164.0 | FmContractList | Form | EMS | This form provides a grid list of all existing contracts on the |
| | | | | system. Options exist on this form to add, change or |
| | | | | delete a contract. This form also includes extensive lookup |
| | | | | and company letter tab's for searching all contracts. |
| 165.0 | FmDailyPrices | Form | PCC | This form shows the graphs of the revenue detail |
| | | | | information on the Producer Control Center. |
| 166.0 | FmDealClassificationUpdates | Form | EMS | This form provides the mechanism for changing any |
| | | | | calculation rules associated with a given combination of |
| | | | | deal classification codes. The WASP inclusion indicator is |
| | | | | stored on this table. |
| 167.0 | fmDealCorrespondenceDetail | Form | EMS | This form provides an entry form for attaching electronic |
| | | | | correspondence to a deal. |
| 168.0 | FmDealCostsEntryDetail | Form | EMS | This form provides for the entry of ‘Other-Costs’ associated |
| | | | | with a particular deal. |
| 169.0 | FmDealDetail | Form | EMS | This is the main detail form that shows all of the |
| | | | | information relative to a deal. |
| 170.0 | FmDealEntryNew | Form | EMS | This form represents a popup box that is displayed when a |
| | | | | new deal has been requested. This box prompts the user |
| | | | | for the type of deal (purchase or sale) and what product |
| | | | | and service it is applicable toward. |
| 171.0 | FmDealList | Form | EMS | This form provides a listing of all ‘Purchase’ or ‘Sales’ |
| | | | | deals within a given month on a grid. Options exist on this |
| | | | | screen to add, change or delete a deal. |
| 172.0 | FmDealPrice | Form | EMS | This is the form that is used whenever a user wants to |
| | | | PCC | calculate the prices for a given volume within a given |
| | | | | month. The only options on this form are to ‘Price All’ and |
| | | | | only for those production months and volumes that are |
| | | | | applicable (based on monthly status). |
| 173.0 | FmDealPriceEntryDetail | Form | EMS | This is the main form for entering deal price information |
| | | | | within the Energy Management System. The primary |
| | | | | underlying tables that get updated include Engine_Master |
| | | | | and Engine_MasterPrice. |
| 174.0 | FmException | Form | EMS | This form is invoked whenever a system exception occurs |
| | | | PCC | within the system. In order to complete the exception a |
| | | | | particular user must have a ‘Super ID’ for the function and |
| | | | | he/she must provide an exception reason with a |
| | | | | description. |
| 175.0 | FmExceptionCategotiesDetail | Form | EMS | This form provides for a detail update screen to update |
| | | | | reason code information for a given type of exception. |
| 176.0 | fmExceptionCategoriesList | Form | EMS | This form provides a listing grid of all reason code |
| | | | | exceptions for a given type of exception. |
| 177.0 | FmGraphicViewer | Form | EMS | This form provides an ability to view graphic images and/or |
| | | | | scan in graphic images from a scanner. These images can |
| | | | | be attached to a deal. |
| 178.0 | fmGroupMemberDetail | Form | EMS | This form represents the detail form for associating a |
| | | | | contact as a member of a specific group. |
| 179.0 | FmImagesDetail | Form | EMS | This form represents the detail form used for posting |
| | | | | updates to the application graphic images (logo’s. etc.). |
| 180.0 | FmImagesList | Form | EMS | This form provides a list of all graphic images (logos) that |
| | | | | are currently stored in the system. |
| 181.0 | FmIndexBasketDetail | Form | EMS | This form provides a detail update screen to update index |
| | | | | price basket information. |
| 182.0 | FmIndexBasketLinkDetail | Form | EMS | This form provides a detail update form to allow for the |
| | | | | updating of index links to particular baskets. |
| 183.0 | FmIndexBasketList | Form | EMS | This form provides a listing grid of all index baskets on the |
| | | | | system. |
| 184.0 | FmLegDailyDetail | Form | EMS | This form provides the detail rate information associated |
| | | | | with a daily leg rate (which overrides the monthly rate |
| | | | | when setup on EMS). |
| 185.0 | FmLegDailyList | Form | EMS | This form provides a listing of all daily rates that may be |
| | | | | setup for a particular leg. |
| 186.0 | FmLegDetail | Form | EMS | This form provides the detail rate information associated |
| | | | | with the a given leg, on a given production month within |
| | | | | the system. Both nomination and actual rate information is |
| | | | | available. |
| 187.0 | FmLegHistory | Form | EMS | This form provides a historical list of all monthly leg rates |
| | | | | that have been established for a given leg. |
| 188.0 | FmLegList | Form | EMS | This form provides a list of all legs on the system. Options |
| | | | | exist from this screen to select and change (modify) the |
| | | | | specific rate information about a leg. |
| 189.0 | FmLegMonthlyView | Form | EMS | This form represents a ‘view’ form that provides a read- |
| | | | | only view of all volumes transported in, out, sold and/or on |
| | | | | balance for a specific meter. |
| 190.0 | FmLegPurchaseLinkMonthlyView | Form | EMS | This form represents a ‘view’ form that provides a read- |
| | | | | only view of all the purchase deals (volumes) that have |
| | | | | been attributed to a selected sale. |
| 191.0 | FmLegPurchaseLinkView | Form | EMS | This form represents a ‘view’ form that provides a read- |
| | | | | only view of all purchases linked to a specific sale on a |
| | | | | given day. |
| 192.0 | FmLegPurchasePointView | Form | EMS | This form represents a ‘view’ form that provides a read- |
| | | | | only view of the originating (hop 0) information for any |
| | | | | given volume that is displayed on the routing screen(s). |
| 193.0 | FmLegRoute | Form | EMS | This is the main routing screen. Options exist on this |
| | | | | screen to select pipe/fields, days, noms or actuals, etc. |
| | | | | With appropriate security a person can transport and/or |
| | | | | sell volume through this panel. |
| 194.0 | FmLegSale | Form | EMS | This form is used as a confirm form for posting volume |
| | | | | balances to a sale. |
| 195.0 | FmLegSalesView | Form | EMS | This form represents a ‘view’ form that provides a read- |
| | | | | only view of all sales that exist on a given pipe/field for |
| | | | | either a single day or an entire month. |
| 196.0 | FmLegTransport | Form | EMS | This form is used as a confirm form for transporting |
| | | | | volumes to other meters (pools). Options also exist on this |
| | | | | form to selectively override transport, gathering, pvr or fuel |
| | | | | rates associated with the transport. |
| 197.0 | FmLegChange | Form | EMS | This form is used whenever a request is made to change |
| | | | | the instructions (either volume or rates) on an existing |
| | | | | transport OR sale route item. |
| 198.0 | fmLegDelete | Form | EMS | This form is used whenever a routed volume (either |
| | | | | transported to a pool or posted to a sale) has been |
| | | | | requested to be deleted. |
| 199.0 | FmLocationsDetail | Form | EMS | This form provides a detail update form to allow for the |
| | | | | updating of location information. These location entries |
| | | | | are used throughout the system (versus hardcoding |
| | | | | locations within the software). |
| 200.0 | fmLocationsList | Form | EMS | This form provides a list form to allow for showing the |
| | | | | location information. These location entries are used |
| | | | | throughout the system (versus hardcoding locations within |
| | | | | the software). |
| 201.0 | fmLogin | Form | EMS | This is the common login form used by the application(s). |
| | | | PCC | It provides the mechanism for authenticating users or |
| | | | | company contacts upon entry into the system. |
| 202.0 | fmLoginChange | Form | EMS | This form provides the users of the system with the ability |
| | | | | to change their login passwords. |
| 203.0 | fmLookup | Form | EMS | This form provides a standard lookup dialog that allows for |
| | | | PCC | queries to be run for nearly all other list forms within the |
| | | | | system. Most list screens provide a lookup button |
| | | | | (binoculars) that will invoke this form. |
| 204.0 | fmMessageBox | Form | EMS | This form displays all system messages used within the |
| | | | PCC | system. This particular form gets utilized by nearly all |
| | | | | other form on the system. The messages displayed by this |
| | | | | form include all ERROR, CONFIRMATIONAL, |
| | | | | INFORMATIONAL and IN-PROCESS oriented messages. |
| 205.0 | fmMeterAllocationsDetail | Form | EMS | This form provides for an entry screen for entering |
| | | | | allocation companies and accounting cross reference deck |
| | | | | codes for a given meter/well and effective date. |
| 206.0 | FmMeterDetail | Form | EMS | This form provides for a detail update form on meter/well |
| | | | | information within the system. |
| 207.0 | fmMeterList | Form | EMS | This form provides for a list form of all meters/wells within |
| | | | | the system. |
| 208.0 | fmMeterRatesDetail | Form | EMS | This form provides for an entry screen for entering rates |
| | | | | (pressure base, Btu factor, pipe/field pressure base, etc.) |
| | | | | for a given meter/well on a specific effective date. |
| 209.0 | FmMeterRevenue | Form | PCC | This form provides a meter/well form that shows graphic |
| | | | | representation of calculated volumes and prices. |
| 210.0 | FmMeterTotals View | Form | EMS | This form provides a ‘view’ which is a read-only view of all |
| | | | | the meter totals (actualized versus not actualized) for an |
| | | | | entire month). A specific deal OR all deals within a month |
| | | | | can be viewed through this form. |
| 211.0 | FmMonthlyStatusDetail | Form | EMS | This form provides a screen for updating the detail |
| | | | | production month status information. This is where users |
| | | | | will go to change the status for each production month |
| | | | | (depending on security level of the user). |
| 212.0 | FmMonthlyStatusList | Form | EMS | This form provides a grid list of all monthly status |
| | | | | information (by status). Options exist here to invoke the |
| | | | | detail update screen to update monthly status information |
| | | | | (with appropriate security). |
| 213.0 | fmNetBackTierDetail | Form | EMS | This form provides the detail form for updating the netback |
| | | | | pricing tiers for a given contract. These tiers are |
| | | | | referenced (for all WASP classified deals) during the |
| | | | | pricing function. |
| 214.0 | FmOGISFeeds | Form | EMS | This form provides an entry form for specifying the |
| | | | | parameters used to create the OGIS journal entry and |
| | | | | revenue receivable accounting feeds. The actual text files |
| | | | | are created from this form. |
| 215.0 | FmPickACompany | Form | EMS | This form provides a common mechanism for displaying a |
| | | | PCC | list of companies to a user and having one of them |
| | | | | selected and carried back to the requesting form. |
| 216.0 | FmPickAContact | Form | EMS | This form provides a common mechanism for displaying a |
| | | | | list of contacts to a user and having one of them selected |
| | | | | and carried back to the requesting form. |
| 217.0 | FmPickAContract | Form | EMS | This form provides a common mechanism for displaying a |
| | | | | list of contracts to a user and having one of them selected |
| | | | | and carried back to the requesting form. |
| 218.0 | FmPickADeal | Form | EMS | This form provides a common mechanism for displaying a |
| | | | | list of deals to a user and having one of them selected and |
| | | | | carried back to the requesting form. |
| 219.0 | FmPickADealMeter | Form | EMS | This form provides a common mechanism for displaying a |
| | | | | list of deal meters to a user and having one of them |
| | | | | selected and carried back to the requesting form. |
| 220.0 | FmPickALeg | Form | EMS | This form provides a common mechanism for displaying a |
| | | | | list of leg (monthly routes) to a user and having one of |
| | | | | them selected and carried back to the requesting form. |
| 221.0 | FmPickALegRef | Form | EMS | This form provides a common mechanism for displaying a |
| | | | | list of LegRef (master routes) to a user and having one of |
| | | | | them selected and carried back to the requesting form. |
| 222.0 | FmPickALegSale | Form | EMS | This form provides a common mechanism for displaying a |
| | | | | list of sales points available for routing to a user and |
| | | | | having one of them selected and carried back to the |
| | | | | requesting form. |
| 223.0 | FmPickAMeter | Form | EMS | This form provides a common mechanism for displaying a |
| | | | | list of meters/wells to a user and having one of them |
| | | | | selected and carried back to the requesting form. |
| 224.0 | FmPickAPipeline | Form | EMS | This form provides a common mechanism for displaying a |
| | | | | list of pipe/fields to a user and having one of them selected |
| | | | | and carried back to the requesting form. |
| 225.0 | fmPickAReport | Form | EMS | This form provides a common mechanism for displaying a |
| | | | | list of reports to a user and having one of them selected |
| | | | | and carried back to the requesting form. |
| 226.0 | FmPipeDetail | Form | EMS | This form provides the detail update form for updating |
| | | | | pipe/field information on the system. |
| 227.0 | fmPipelineActuals | Form | EMS | This is the main form used for enter actual volumes for |
| | | | | meters/wells on the system. The form includes a |
| | | | | calculator function for propagating the volumes across all |
| | | | | days for the highlighted meter/well. |
| 228.0 | fmPipeList | Form | EMS | This form provides the list form to show all pipe/fields |
| | | | | currently defined within the system. Options exist on this |
| | | | | form to add, update or delete a pipe/field. |
| 229.0 | FmPriceComponentsDetail | Form | EMS | This form provides the screen for updating the detail ‘price |
| | | | | tags’ that have been setup on the system. These price |
| | | | | tags allow us to identify the various portions of a sale or |
| | | | | purchase price. |
| 230.0 | FmPriceComponentsList | Form | EMS | This form provides a grid list of all price components (tags) |
| | | | | that have been setup on the system. |
| 231.0 | fmPriceIndexUpdates | Form | EMS | This form provides a list of all prices for the daily index |
| | | | | Prices. When entering this form the default date is set to |
| | | | | the current date. When prices are being entered on |
| | | | | ‘Mondays’ there is a ‘copy to previous weekend’ button |
| | | | | which will allow for all prices to be propagated back to the |
| | | | | previous weekend. Monthly index prices are entered on |
| | | | | day 1 only for a given month. |
| 232.0 | FmPriceIndicesDetail | Form | EMS | This form provides a screen for updating the price index |
| | | | | information on the database (IndexRef table). This |
| | | | | includes display order, name, etc. |
| 233.0 | FmPriceIndicesList | Form | EMS | This form provides an ‘updateable’ grid list that shows all |
| | | | | price indices on the system. Options exist here to invoke |
| | | | | the add/update function (fmPriceIndicesDetail). |
| 234.0 | fmPricesByIndexList | Form | EMS | This form provides a graphic and tabular view of index |
| | | | PCC | prices for a given month. |
| 235.0 | FmPrinterDetail | Form | EMS | This form provides a detail entry form for updating the |
| | | | | printer information stored on the system. |
| 236.0 | fmPrinterList | Form | EMS | This form provides a list form that shows all printers |
| | | | | currently defined on the system. |
| 237.0 | FmProcessingCodesDetail | Form | EMS | This form provides the detail form for updating a given set |
| | | | | of reference (processing codes). |
| 238.0 | FmProcessingCodesList | Form | EMS | This form provides the list form for showing all of the |
| | | | | processing codes. Options exist on this form to add, |
| | | | | update or delete a given code. |
| 239.0 | FmProcessingCodesPick | Form | EMS | This form provides an ability to ‘pick’ a particular reference |
| | | | | code and send it back to the form that invoked the screen. |
| 240.0 | FmProcessingCodeTypesDetail | Form | EMS | This form provides the detail form for updating a given set |
| | | | | of processing code types (types of reference codes). |
| 241.0 | fmProcessingCodeTypesList | Form | EMS | This form provides the list form for showing all of the |
| | | | | processing code types. Options exist on this form to add, |
| | | | | update or delete a given type. |
| 242.0 | FmProdVolCofirms | Form | EMS | This form provides the mechanism for recognizing volumes |
| | | | | that were returned by producers. In addition, options exist |
| | | | | on this form to send out producer confirmations. |
| 243.0 | FmProdVolHist | Form | EMS | This form provides a history list of royalty and makeup |
| | | | | percentage interests, by the owner, for a given meter/well. |
| 244.0 | FmProdVolList | Form | EMS | This form provides the mechanism for entering initial |
| | | | | volumes (expected availability) from producers. Option |
| | | | | exist on this form to send out producer availability estimate |
| | | | | reports. |
| 245.0 | FmReportDefaultsDetail | Form | EMS | This form provides a detail screen for setting up the default |
| | | | | reports that will be used by entity, product and service on |
| | | | | the system. These reports include invoices, vouchers, |
| | | | | remittance, etc. |
| 246.0 | FmReportDefaultsList | Form | EMS | This form provides a list screen for showing all of the |
| | | | | default reports that are setup by entity, product and service |
| | | | | on the system. These reports include invoices, vouchers, |
| | | | | remittance, etc. |
| 247.0 | FmReportOverridesDetail | Form | EMS | This form provides a detail screen for setting up the |
| | | | | override reports that will be used by entity, product and |
| | | | | service on the system ASSOCIATE TO A SPECIFIC |
| | | | | CONTRACT. These reports include invoices, vouchers, |
| | | | | remittance, etc. |
| 248.0 | FmReportsList | Form | EMS | This is the primary form used for displaying a reporting |
| | | | PCC | folder. Within this folder are all of the reporting ‘tabs’ that |
| | | | | are available. Within each tab are all of the specific reports |
| | | | | that can be run. A submission, and view button are |
| | | | | available here. |
| 249.0 | FmReportsParameters | Form | EMS | This is the form that is used when entering the various |
| | | | PCC | parameters when a report is submitted. Defaults are |
| | | | | automatically supplied and the parameters are listed in a |
| | | | | grid list format. |
| 250.0 | fmReportsView | Form | EMS | This is the main view form for viewing all of the submitted |
| | | | PCC | reports. Options exist to view the reports specifically |
| | | | | submitted by a user OR to view the reports that were |
| | | | | submitted by the scheduler. |
| 251.0 | fmSecurityAuthDetail | Form | EMS | This form represents the form for establishing and updating |
| | | | | security authorizations between users and business |
| | | | | functions within the Energy Management System. Options |
| | | | | exist here to allow for users to have NO ACCESS, READ |
| | | | | ONLY, READ/UPDATE, READ/UPDATE/DELETE or |
| | | | | SUPER access to a particular area of application. |
| 252.0 | fmSecurityAuthList | Form | EMS | This form provides a listing of all security authorizations |
| | | | | that are set for each user on the Energy Management |
| | | | | System. Options exist on this form to add, update and |
| | | | | delete specific security authorizations for any given user of |
| | | | | the system. |
| 253.0 | FmsRptsinvoice | Form | EMS | This is the primary form used for submitting standard |
| | | | | invoice reports. |
| 254.0 | FmsRptsRemittance | Form | EMS | This is the primary form used for submitting standard |
| | | | | remittance reports. |
| 255.0 | fmsRptsVoucher | Form | EMS | This is the primary form used for submitting standard |
| | | | | voucher reports. |
| 256.0 | FmTransactionDetail | Form | EMS | This form provides for the entry of ‘Other Cost’ transactions |
| | | | | within EMS. Once these transactions are setup in the |
| | | | | system, then they can be attached to deals and |
| | | | | calculations will be done against them. |
| 257.0 | FmTransactionList | Form | EMS | This form provides a list of all the ‘Other Cost’ transactions |
| | | | | that have been setup on the system. |
| 258.0 | fmUserProfilesDetail | Form | EMS | This form represents the creation and update form for all |
| | | | | users on the Energy Management System. This form |
| | | | | provides an administrator with the ability to change name, |
| | | | | password, title, default printer, etc. for all users on the |
| | | | | system. |
| 259.0 | fmUserProfilesList | Form | EMS | This form provides a listing of all users that are capable of |
| | | | | using the Energy Management System. Options exist on |
| | | | | this form to add, update or delete a specific user. |
| 260.0 | fmGasControlMainMenu | Form | EMS | This form represents the main menu for the Energy |
| | | | | Management System. All menu options, speed buttons, |
| | | | | etc are stored on this form. This particular form is also |
| | | | | responsible for invoking the methods to establish a |
| | | | | connection and set the form screen attributes (based on |
| | | | | user preferences). |
| 261.0 | fmProducerControlCenterMain | Form | PCC | This form represents the main menu for the Producer |
| | | | | Control Center. All menu options, speed buttons, etc are |
| | | | | stored on this form. This particular form is also responsible |
| | | | | for invoking the methods to establish a connection and set |
| | | | | the form screen attributes (based on user preferences). |

### APPLICATION (CLIEN-SIDE) SOFTWARE

The table that follows contains the high-level documentation related to the systems and methods provided by the present invention and, in particular, those sub-functions and applications that run client-side in the context of the present invention. In the table that follows, the terms EMS and PCC are used to differentiate (as described above), between a full use application system and a limited use/user/function application system that are provided by the present invention. The actual source code for such application software is contained among the files found on the attached compact disc.

### PRICING AND PRICING TECHNIQUES

So far in the aforementioned detailed discussion the present invention, it has been assumed that the particular pricing techniques may be employed to price one or more fuel deals automatically. The present invention certainly permits fuel deals to be priced based on a variety of factors germane to the energy field. Additionally, the systems and methods provided by the present invention permit fuel deals to be priced automatically, in batch or otherwise, based on pricing techniques which are modularized and which are carried out automatically based on prior or other collections of fuel deals and other fuel deal data. Accordingly, teams of sales personnel can have deals priced based on company specifications to meet margin requirements, etc.

One such technique implemented as a modularized process capable of pricing one or more fuel deals in accordance with the present invention is referred to as the WASP technique which stands for the Weighted Average Selling Price technique. WASP permits one or more fuel deals (usually a collection) to be priced to meet organization pricing targets (and margin requirements) based on computed average sales prices across collections of fuel deals. The WASP technique and its supporting computer software are contained herein for purposes of example to illustrate the novelty of having a system that can incorporate a substitutable pricing technique (algorithm) into a business process like or similar to the one depicted in and discussed in regard to FIG. 1.

### The WASP Calculation

This particular section contains information on the calculation that occurs to price deals. In the context of the present invention, it is envisioned that there are three situations that can trigger a pricing calculation:

1. The price calculation can be submitted at any time by individuals with appropriate security using the System online pricing screen (see FIGS. 4A-4Q). Only those production months in a ‘Sales’ (nomination recalculated) or ‘Invoiced’ (actual recalculated) status can be submitted through this screen;

2. When the status for a production month goes from ‘Sales’ to ‘Invoiced’ a final nomination is performed. In addition, when the status of a production month goes from ‘Invoiced’ to ‘Accounting’ a final actuals calculation is performed. These production month status ‘promotions’ occur through the EMS online screens (by individuals with an appropriate level of security); and

3. Each evening, for example, all production months that are in either the ‘Sales’ or ‘Invoice’ status will have a calculation cycle run for them. This calculation begins at approximately 8:00 CST, for example. This ensures that all variables (price index entries, volumes, routing instructions, etc.) that could influence the price of a given set of deals are recalculated and presented as current, the first thing in the morning.

The entire calculation process is comprised entirely of MS SQL-Server Transact-SQL stored procedures. The ‘flow’ of the calculation can be described with reference to the following six (6) stages:

Stage 1. Sales Deal Calculations

Calculate all sales deals first (all pools and deal classifications). This is done because knowing the sales prices (by pool) is required for the following purchase deal calculations.

Stage 2 WASP Deal Preparation

This particular stage simply prepares the WASPResolvedRouting table with initial sales pool total dollars and volumes. This is the primary table that is used when repeatedly (such as via iteration) tracing all volumes from the sales point back to originating purchase points.

Stage 3 Purchase Deal ‘None’ Pool (3^{rd} Party) Calculations

All third party purchase deals (belonging to the ‘None’ (pool) are calculated first. The reason for this is because of the potential that some of these deals having Financial Overrides that are to be distributed to either a ‘Common’ WASP pool OR to a specific deal. By doing these calculations first, the profit gain or loss (for the financial overrides) can be determined and posted to the appropriate place in the WASPResolvedRouting table.

Stage 4 Purchase Deal ‘Dedicated’ Pool (Sanctioned Sales) Calculations

All sanctioned sales purchase deals are now calculated. The price for these purchases is driven based on a weighted average basis of the sales meters. Sanctioned sale purchase exist in their own pool (‘Dedicated’) so that no other purchases volumes (and sales of those volumes) will impact the price calculated. Netback percentages are applied.

Stage 5 Purchase Deal ‘Common’ Pool (Equity) Calculations

All equity deals are then calculated. The price for these purchases is driven based on a weighted average basis of the sales meters. All purchases that are classified as ‘equity’ will share in pricing and costing (weighted). The pricing is based on the ‘common’ body. Any given purchase deal classified as equity could potentially impact the price that other purchase deals (in the ‘common’ pool) calculates. Netback percentages are applied.

Stage 6 Transportation Costs

This stage of the calculation aggregates all of the transport volumes throughout the month to special transport deals and volume inventory items.

Each of the aforementioned stages of the calculation are invoked from a stored procedure called usp_PSPriceAutoMonth. FIGS. 5A and 5B illustrate the process flows corresponding to these ‘stages’ and the flow of the stored procedures (discussed above) invoked during the calculation. The ordering of these procedures can be tied back to the stages just described above. Actual WASP calculation routines are listed below to aid the reader to completely understand the nature using a predetermined pricing technique in accordance with the present invention.

### Weighted Average Sales Price Calculation Routines

The following software routines implement a weighted average sales pricing technique that may be incorporated within a computing environment such as within a server-side processing system to facilitate fuel deal pricing in accordance with a preferred embodiment of the present invention. Accordingly, in the context of the instant invention, the following routines provide a predetermined pricing technique for pricing fuel deals based on past, present, or future deals, or combinations thereof. The following routines are found among the files contained on the attached compact disc, and also have been commented to assist those of ordinary skill in the art understand the details related to actual implementation.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

### ADDITIONAL FEATURES

The present invention has been disclosed, illustrated, and described in relation to a client-server application that facilitates pricing and distribution of fuel to a customer. Although centralized data storage and manipulation is preferred in regard to the version of the system that has been provided, the inventors contemplate other applications and enhancements that certainly are within the scope of the present invention. For example, the present invention relies on data inputs and feeds from a variety of entities such as producers, transporters, etc. Although such data inputs are often entered manually into the systems provided by the present invention, such data inputs could be automatically delivered and stored within data store 106 (FIG. 2). For example, transporters controlling actual meters along a gas pipeline, for example, could be outfitted with remote sensors and transmitters that provide shipment volume, etc. details directly to the systems provided by the present invention. Moreover, data inputs such as indexing datum used to drive pricing, etc. may be similarly obtained. And, since such data inputs can come from a variety of sources, modern communications technologies such as the Internet, wireless technologies, etc. could all be used to couple an operator of the systems and methods provided by the present invention with such sources. Accordingly, the present invention is not limited to any particular data retrieval system, topology, method, or paradigm. Those skilled in the art will be immediately able to adapt and modify the underlying data collection capabilities of the systems and methods provided by the present invention to incorporate such new and modern technologies and techniques.

Finally, it should be noted that the present invention contemplates and provides for an elaborate reporting capability as provided within the software contained on the attached compact disc. Those skilled in the art of computer programming and those familiar with fuel deal management will immediately understand that any number of report may be prepared to suit and satisfy management requirements. The database tables maintained by the present invention certainly support all types of relational type queries that such reports may require.

Thus, having fully described the present invention by way of example with reference to the attached drawing figures, it will be readily appreciated that many changes and modifications may be made to the invention and to any of the exemplary embodiments shown and/or described herein without departing from the spirit or scope of the invention which is defined in the appended claims.

What is claimed is:

1. A method for facilitating sale and distribution of fuel to a fuel customer, comprising the following step:
at a server facility, storing store fuel deal data, and processing said fuel deal data to automatically generate pricing data based on said fuel deal data and in accordance with a predetermined pricing technique;
at a client facility coupled to said server facility via an electronic data network, permitting a user to enter said fuel deal data and to cause said server facility to store and process said fuel deal data to automatically generate said pricing data; and
permitting said fuel to be sold and distributed to a fuel customer via a fuel distribution system based on said fuel deal data and said automatically generated pricing data.

1. The method according to claim 1, wherein said server facility and said client facility are coupled to each other via the Internet.

2. The method according to claim 1, wherein said server facility and said client facility are coupled to each other via open standards based protocols.

3. The method according to claim 1, wherein said server facility includes a data storage facility storing said fuel deal data.

4. The method according to claim 1, wherein said server facility automatically generates said pricing data periodically.

5. The method according to claim 1, wherein said server facility is further configured to be accessed by a plurality of other client facilities simultaneously.

6. The method according to claim 1, wherein said client facility is remotely located away from said server facility and said client facility acts as a data collection point for collecting data that said server facility uses in automatically generating said pricing data.

7. The method according to claim 1, wherein said predetermined pricing technique involves basing prices for fuel deals based on past fuel deals.

8. The method according to claim 1, wherein said predetermined pricing technique involves said server facility generating a weighted average selling price based on prior fuel deals.

9. The method according to claim 1, wherein said predetermined pricing technique is implemented within said server facility as a software module running within said server facility.

10. A method for facilitating sale and distribution of fuel to a fuel customer, comprising the steps of:
at a server facility, storing fuel deal data, and processing said fuel deal data to automatically generate pricing data based on said fuel deal data and in accordance with a predetermined pricing technique, said predetermined pricing technique controlling said server facility to compute fuel prices based on weighted averages of fuel prices maintained within said fuel deal data;
at a client facility outfitted with a client application and coupled to said server facility via an electronic data network, permitting a user to enter said fuel deal data and to cause said server facility to store and process said fuel deal data to generate said pricing data, said client application configured to access said electronic data network and to establish communications with said server facility; and
permitting said fuel to be sold and distributed to a fuel customer via a fuel distribution system based on said fuel deal data and said automatically generated pricing data.

11. The method according to claim 10, wherein said server facility and said client facility are coupled to each other via the Internet.

12. The method according to claim 10, wherein said server facility and said client facility are coupled to each other via open standards based protocols.

13. The method according to claim 10, wherein said server facility includes a data storage facility storing said fuel deal data.

14. The method according to claim 10, wherein said server facility automatically generated said pricing data periodically.

15. The method according to claim 10, wherein said server facility is further configured to be accessed by a plurality of other client facilities simultaneously.

16. The method according to claim 10, wherein said client facility is remotely located away from said server facility and said client facility acts as a data collection point for collecting data that said server facility uses in automatically generating said pricing data.

17. The method according to claim 10, wherein said predetermined pricing technique involves basing prices for fuel deals based on past fuel deals.

18. The method according to claim 10, wherein said predetermined pricing technique involves said server facility generating a weighted average selling price based on prior fuel deals.

19. The method according to claim 10, wherein said predetermined pricing technique is implemented within said server facility as a software module running within said server facility.

20. The method according to claim 10, further comprising the step of providing a graphical user interface to a user of said client facility, said graphical user interface permitting said user to engage in operations and to cause said server facility to automatically computer said fuel prices.
